(19) United States
(12) Patent Application Publication
(10) Pub. No.: US 2019/0354028 A1
(43) Pub. Date: Nov. 21, 2019

(54) ELECTROGRAPHIC PHOTORECEPTOR MANUFACTURING METHOD

(71) Applicant: KYOCERA Document Solutions Inc., Osaka (JP)

(72) Inventors: Tomofumi SHIMIZU, Osaka-shi (JP); Jun AZUMA, Osaka-shi (JP)

(73) Assignee: KYOCERA Document Solutions Inc., Osaka (JP)

(21) Appl. No.: 16/401,401

(22) Filed: May 2, 2019

(30) Foreign Application Priority Data
May 15, 2018 (JP) 2018-093831

(51) Int. Cl. G03G 5/047; C08G 63/19; C08G 63/87; G03G 5/05

(52) U.S. Cl. CPC G03G 5/047; G03G 5/05; C08G 63/87; C08G 63/19

(57) ABSTRACT

A method of manufacturing an electrographic photoreceptor provided with a conductive substrate and a single-layered photosensitive layer is disclosed. The method includes: directly or indirectly applying a coating liquid for photosensitive layer formation onto the conductive substrate, the coating liquid containing a solvent, a charge generating agent, a binder resin, a hole transport material and an electron transport material; and removing part of the solvent to form the single-layered photosensitive layer. The solvent includes a first solvent as an alcohol with 1 to 3 carbon atoms and a second solvent as a solvent other than the first solvent. The binder resin includes a polyarylate resin as a polymerized product of monomers including a first monomer represented by General Formula (1) below and a second monomer represented by General Formula (2) below. The electron transport material includes a compound represented by General Formula (31), (32), (33) or (34) below.

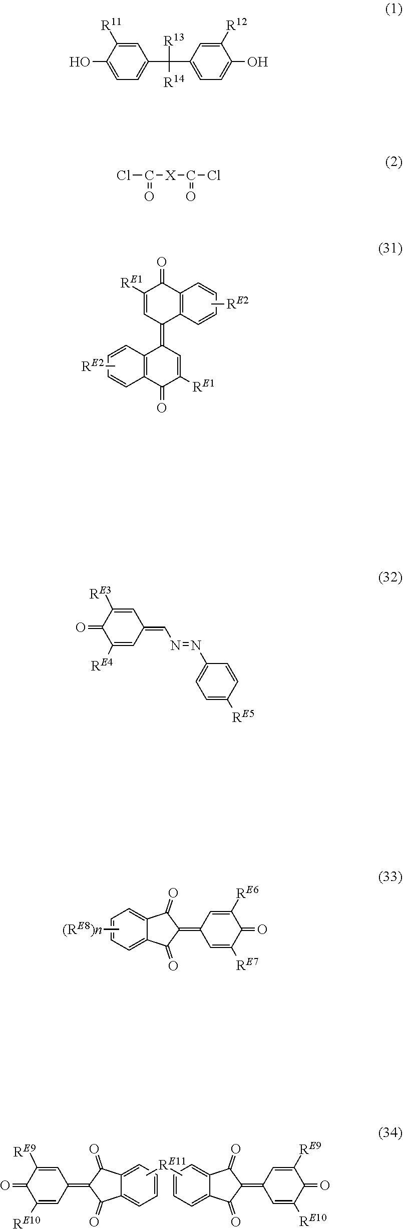

### INCORPORATION BY REFERENCE

The present application claims priority under 35 U.S.C. § 119 to Japanese Patent Application No. 2018-093831 filed on May 15, 2018. The contents of the Japanese application are incorporated herein by reference in their entirety.

### BACKGROUND

### Field of the Invention

The present disclosure relates to electrographic photoreceptor manufacturing methods.

### Description of Related Art

An electrographic photoreceptor is used in an electrographic image forming apparatus (printer or multifunction peripheral, for instance) as an image bearing member. The electrographic photoreceptor as such is provided with a photosensitive layer. Examples of the electrographic photoreceptor include a single-layered electrographic photoreceptor and a multilayered electrographic photoreceptor. The single-layered electrographic photoreceptor is provided with a single-layered photosensitive layer having a charge generating function and a charge transporting function. The multilayered electrographic photoreceptor is provided with a photosensitive layer including a charge generating layer having a charge generating function and a charge transporting layer having a charge transporting function.

It is being discussed to use a polyarylate resin as a binder resin for an exemplary electrographic photoreceptor. The polyarylate resin is obtained by interfacial polycondensation reaction of an aromatic dicarboxylic acid component and an aromatic dihydric alcohol component and has a carboxylic halide terminal represented by General Formula (A) below at a mass ratio of 10 ppm or less. In General Formula (A), PAR represents a polyarylate chain and X represents a halogen atom.

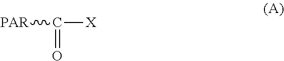

### SUMMARY

The electrographic photoreceptor manufacturing method of the present disclosure is a method of manufacturing an electrographic photoreceptor provided with a conductive substrate and a photosensitive layer, the method including directly or indirectly applying a coating liquid for photosensitive layer formation onto the conductive substrate, the coating liquid containing a solvent, a charge generating agent, a binder resin, a hole transport material and an electron transport material, and removing part of the solvent to form the photosensitive layer. The solvent includes a first solvent as an alcohol with 1 to 3 carbon atoms and a second solvent as a solvent other than the first solvent. The binder resin includes a polyarylate resin as a polymerized product of monomers including a first monomer represented by General Formula (1) below and a second monomer represented by General Formula (2) below. The electron transport material includes a compound represented by General Formula (31), (32), (33) or (34) below.

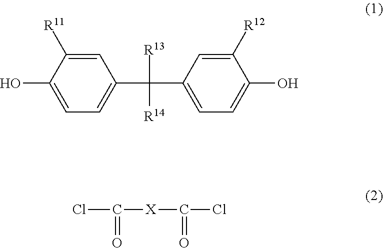

In General Formula (1), R¹¹ and R¹² each independently represent a hydrogen atom or an alkyl group with 1 to 4 carbon atoms. R¹³ and R¹⁴ each independently represent a hydrogen atom, an alkyl group with 1 to 4 carbon atoms or a phenyl group, or R¹³ and R¹⁴ are joined together to represent a divalent group represented by General Formula (Y) below. In General Formula (2), X represents a divalent group represented by Chemical Formula (X1), (X2), (X3) or (X4) below.

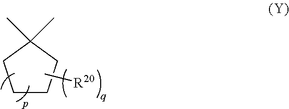

In General Formula (Y), R²⁰ represents a monovalent substituent. The letter p represents an integer between 1 and 6 inclusive. The letter q represents an integer between 0 and 5 inclusive.

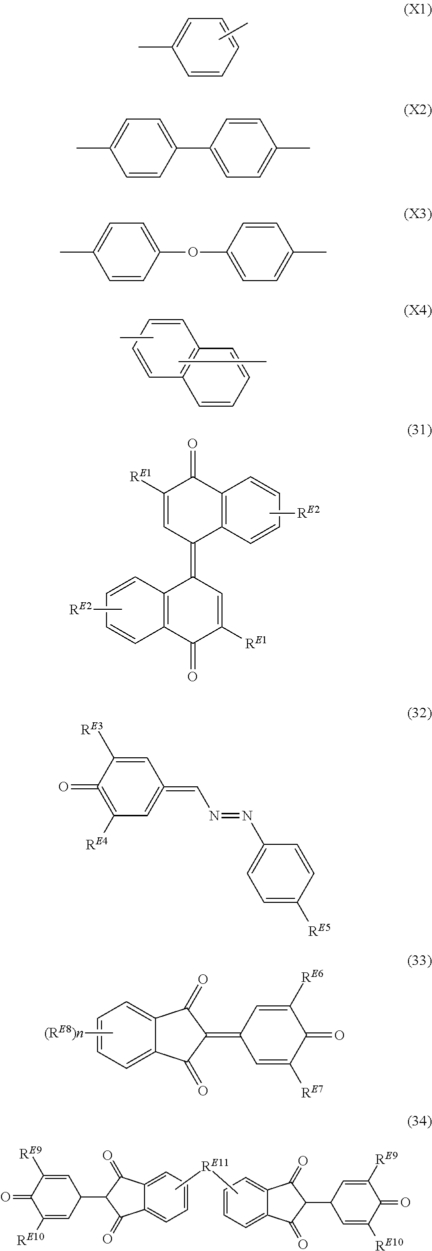

In General Formula (31), R^{E1} and R^{E2} each independently represent a hydrogen atom, an alkyl group with 1 to 8 carbon atoms, a phenyl group or an alkoxy group with 1 to 8 carbon atoms. Two R^{E1} s in the formula may be the same or different from each other. Two R^{E2}s in the formula may be the same or different from each other.

In General Formula (32), R^{E3} and R^{E4} each independently represent a hydrogen atom, an alkyl group with 1 to 8 carbon atoms, a phenyl group or an alkoxy group with 1 to 8 carbon atoms. R^{E5} represents a hydrogen atom, a halogen atom, an alkyl group with 1 to 8 carbon atoms, a phenyl group or an alkoxy group with 1 to 8 carbon atoms.

In General Formula (33), R^{E6} and R^{E7} each independently represent a hydrogen atom, an alkyl group with 1 to 8 carbon atoms, a phenyl group or an alkoxy group with 1 to 8 carbon atoms. R^{E8} represents an alkyl group with 1 to 8 carbon atoms, a phenyl group or an alkoxy group with 1 to 8 carbon atoms. The letter n represents an integer between 0 to 4 inclusive. A plurality of R^{E8}s in the formula may be the same or different from one another if n represents an integer that is 2 or higher.

In General Formula (34), R^{E9} and R^{E10} each independently represent a hydrogen atom, an alkyl group with 1 to 8 carbon atoms, a phenyl group or an alkoxy group with 1 to 8 carbon atoms. R^{E11} represents a single bond or an alkanediyl group with 1 to 8 carbon atoms. Two R^{E9}s in the formula may be the same or different from each other. Two R^{E10}s in the formula may be the same or different from each other.

### BRIEF DESCRIPTION OF THE DRAWINGS

FIG. 1 is a local sectional view of an example of an electrographic photoreceptor obtained by an electrographic photoreceptor manufacturing method according to a first aspect of the present disclosure,

FIG. 2 is a local sectional view of another example of the electrographic photoreceptor obtained by the electrographic photoreceptor manufacturing method according to the first aspect of the present disclosure,

FIG. 3 is a local sectional view of yet another example of the electrographic photoreceptor obtained by the electrographic photoreceptor manufacturing method according to the first aspect of the present disclosure,

FIG. 4 is a local sectional view of an example of an image forming apparatus according to a fourth aspect of the present disclosure,

FIG. 5 is a diagram showing an image for evaluation, and

FIG. 6 is a diagram showing an image having a ghost image generated therein.

### DETAILED DESCRIPTION

In the following, aspects of the present disclosure are described in detail. The present disclosure is in no way limited to the aspects as described below but may be implemented with modifications appropriately made within the scope of purpose of the present disclosure. Description may be omitted with respect to the same or like parts, which does not limit the gist of disclosure. In the present specification, a compound and derivatives thereof may comprehensively be called by the name of the compound that is followed by the suffix “-based.” By the name of a polymer as expressed by adding the suffix “-based” to the name of a compound, it is meant that the repeating unit of the polymer is derived from the compound or a derivative thereof.

In the description, an alkyl group with 1 to 8 carbon atoms, an alkyl group with 4 to 6 carbon atoms, an alkyl group with 1 to 4 carbon atoms, an alkoxy group with 1 to 8 carbon atoms, an alkoxy group with 1 to 4 carbon atoms, and a halogen atom are defined as follows.

An alkyl group with 1 to 8 carbon atoms, an alkyl group with 4 to 6 carbon atoms, and an alkyl group with 1 to 4 carbon atoms are each linear or branched, and each unsubstituted. Examples of the alkyl group with 1 to 8 carbon atoms include methyl group, ethyl group, propyl group, isopropyl group, n-butyl group, s-butyl group, t-butyl group, pentyl group, isopentyl group, neopentyl group, hexyl group, heptyl group, and octyl group. Examples of the alkyl group with 4 to 6 carbon atoms and the alkyl group with 1 to 4 carbon atoms include those examples of the alkyl group with 1 to 8 carbon atoms which are each a group with 4 to 6 carbon atoms or a group with 1 to 4 carbon atoms.

An alkoxy group with 1 to 8 carbon atoms and an alkoxy group with 1 to 4 carbon atoms are linear or branched, and unsubstituted. Examples of the alkoxy group with 1 to 8 carbon atoms include methoxy group, ethoxy group, n-propoxy group, isopropoxy group, n-butoxy group, s-butoxy group, t-butoxy group, pentyloxy group, isopentyloxy group, neopentyloxy group, hexyloxy group, heptyloxy group, and octyloxy group. Examples of the alkoxy group with 1 to 4 carbon atoms include those examples of the alkoxy group with 1 to 8 carbon atoms which are each a group with 1 to 4 carbon atoms.

Exemplary halogen atoms include a fluorine atom, a chlorine atom, a bromine atom, and an iodine atom.

(First Aspect: Electrographic Photoreceptor Manufacturing Method)

The method of manufacturing an electrographic photoreceptor (hereafter also referred to simply as “photoreceptor”) according to a first aspect of the present disclosure is a method of manufacturing a photoreceptor provided with a conductive substrate and a single-layered photosensitive layer, the method including directly or indirectly applying a coating liquid for photosensitive layer formation onto the conductive substrate, the coating liquid containing a solvent, a charge generating agent, a binder resin, a hole transport material and an electron transport material, and removing part of the solvent to form the single-layered photosensitive layer. The solvent includes a first solvent and a second solvent described later. The binder resin includes a polyarylate resin described later. The electron transport material includes electron transport materials (31) through (34) described later.

A photoreceptor formed by the photoreceptor manufacturing method according to the first aspect makes it possible to suppress a ghost image. Exemplary ghost images include a ghost image due to the exposure memory phenomenon and a ghost image due to the transfer memory phenomenon.

The ghost image due to the exposure memory phenomenon refers to the image defect in which, in the formed image, a region corresponding to an exposed region of the photoreceptor in the previous turn is darkened. The exposure memory phenomenon is the phenomenon in which, on the photoreceptor surface, the charging potential in a region corresponding to an exposed region in the previous turn is reduced under the influence of exposure as compared with the charging potential in a region corresponding to an unexposed region in the previous turn.

The ghost image due to the transfer memory phenomenon refers to the image defect in which, in the formed image, a region corresponding to an unexposed region of the photoreceptor in the previous turn is darkened. The transfer memory phenomenon is the phenomenon in which, on the photoreceptor surface, the charging potential in a region corresponding to an unexposed region in the previous turn is reduced under the influence of transfer bias (bias between the charging polarity and the reverse polarity) as compared with the charging potential in a region corresponding to an exposed region in the previous turn.

First of all, the structure of a photoreceptor obtained by the photoreceptor manufacturing method according to the first aspect is described with reference to FIGS. 1 through 3. FIGS. 1 through 3 are each a cross-sectional view of an example of the photoreceptor obtained by the photoreceptor manufacturing method according to the first aspect (hereafter also referred to as “photoreceptor 1”).

As shown in FIG. 1, the photoreceptor 1 is provided with a conductive substrate 2 and a photosensitive layer 3, for instance. The photosensitive layer 3 is a single layer (monolayer). In other words, the photoreceptor 1 is a single-layered electrographic photoreceptor that is provided with the photosensitive layer 3 as a single layer.

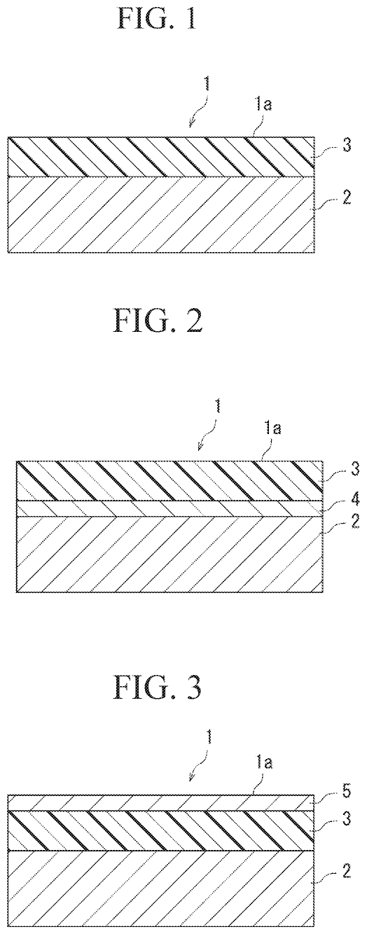

The photoreceptor 1 may be provided with the conductive substrate 2, the photosensitive layer 3, and an intermediate layer 4 (undercoat layer), as shown in FIG. 2. The intermediate layer 4 is provided between the conductive substrate 2 and the photosensitive layer 3. As shown in FIG. 1, the photosensitive layer 3 may be provided directly on the conductive substrate 2. The photosensitive layer 3 may also be provided on the conductive substrate 2 through the intermediate layer 4, as shown in FIG. 2. The intermediate layer 4 may be composed of a single layer or multiple layers.

The photoreceptor 1 may also be provided with the conductive substrate 2, the photosensitive layer 3, and a protective layer 5, as shown in FIG. 3. The protective layer 5 is provided on the photosensitive layer 3. The protective layer 5 may be composed of a single layer or multiple layers. The structure of the photoreceptor 1 has been described above with reference to FIGS. 1 through 3. Now, the respective elements (conductive substrate, photosensitive layer, and intermediate layer) of the photoreceptor are described in detail.

(Conductive Substrate)

The conductive substrate is not particularly limited as long as the substrate is usable as a conductive substrate for a photoreceptor. The conductive substrate is only required to have at least a surface portion made of a conductive material. A conductive substrate made of a conductive material may be mentioned as an example of the conductive substrate. A conductive substrate having a conductive material coated thereon may also be mentioned as another example of the conductive substrate. Exemplary conductive materials include aluminum, iron, copper, tin, platinum, silver, vanadium, molybdenum, chromium, cadmium, titanium, nickel, palladium, indium, stainless steel, and brass. Such conductive materials may be used alone or in combination of two or more of them (as an alloy, for instance). Among the conductive materials as above, aluminum and aluminum alloys are preferred because they allow a good charge transfer from the photosensitive layer to the conductive substrate.

The form of the conductive substrate is selected appropriately to the structure of an image forming apparatus. The conductive substrate may be in the form of a sheet or a drum. The thickness of the conductive substrate is selected appropriately to the form of the conductive substrate.

(Photosensitive Layer)

The photosensitive layer contains an alcohol with 1 to 3 carbon atoms, a binder resin, a hole transport material, and an electron transport material. The respective components of the photosensitive layer will be detailed later.

The photosensitive layer is not particularly limited in thickness as long as the layer exerts adequate functions as a photosensitive layer. The thickness of the photosensitive layer is preferably 5 to 100 μm and more preferably 10 to 50 μm.

(Intermediate Layer)

The intermediate layer (undercoat layer) contains inorganic particles and a resin usable in the intermediate layer (resin for the intermediate layer), for instance. The presence of the intermediate layer is considered not only to maintain such an insulating state as capable of suppressing the leak current but allow a smooth flow of a current generated when the photoreceptor is exposed, so as to suppress the increase in resistance.

Examples of the inorganic particles include particles of metal (e.g., aluminum, iron or copper) or a metal oxide (e.g., titanium oxide, alumina, zirconium oxide, tin oxide or zinc oxide) and particles of a nonmetal oxide (e.g., silica). Of the inorganic particles as above, any one type may be used alone or two or more types may be used in combination.

Examples of the resin for the intermediate layer and the additives, which are to be used in the intermediate layer, may include those resins and additives which will be mentioned later as examples of the binder resin and the additives, which are to be used in the photosensitive layer. It, however, is preferable for a good formation of the intermediate layer and photosensitive layer that the resin for the intermediate layer is different from the binder resin to be contained in the photosensitive layer 3.

(Photosensitive Layer Formation Process)

The photoreceptor manufacturing method includes the step of forming a single-layered photosensitive layer by directly or indirectly applying a coating liquid for photosensitive layer formation onto a conductive substrate, the coating liquid containing a solvent, a charge generating agent, a binder resin, a hole transport material and an electron transport material, and removing part of the solvent (hereafter also referred to as “photosensitive layer formation process”).

The coating liquid for photosensitive layer formation is prepared by mixing the components and dispersing them in the solvent. Mixing or dispersing may be carried out using a bead mill, a roll mill, a ball mill, an attritor, a paint shaker or an ultrasonic disperser.

The method to be used to apply the coating liquid for photosensitive layer formation is not particularly limited as long as the method allows a uniform application. Exemplary application methods include dip coating, spray coating, spin coating, and bar coating.

The method to be used to remove part of the solvent contained in the coating liquid for photosensitive layer formation is not particularly limited as long as the method is capable of evaporating the solvent. Exemplary methods include heating, pressure reduction, and a combination of heating and pressure reduction. To be more specific, a heat treatment (hot air drying method) using a high temperature dryer or a vacuum dryer may be mentioned. Exemplary conditions for heat treatment include a temperature of 40 to 150° C. and a treatment time of 3 to 120 minutes. The following description is made on the components of the coating liquid for photosensitive layer formation.

(Solvent)

The solvent to be contained in the coating liquid for photosensitive layer formation includes a first solvent as an alcohol with 1 to 3 carbon atoms (hereafter also referred to as “lower alcohol”) and a second solvent as a solvent other than the first solvent.

Examples of the lower alcohol include methanol, ethanol, 1-propanol, and 2-propanol. From the viewpoint of obtaining a photoreceptor allowing a more effective suppression of a ghost image, methanol is the preferred lower alcohol.

The content ratio of the first solvent in the solvent of the coating liquid for photosensitive layer formation (100× mass of first solvent/total mass of first solvent and second solvent) is preferably 0.5 to 10.0% by mass and more preferably 1.0 to 5.0% by mass. If the above mass ratio of the first solvent is 0.5% by mass or more, a photoreceptor making it possible to suppress a ghost image more effectively is formed. If the above mass ratio of the first solvent is 10.0% by mass or less, the binder resin is easy to dissolve in the coating liquid for photosensitive layer formation, leading to an easy formation of the photosensitive layer.

The second solvent is not particularly limited as long as the charge generating agent, the binder resin, the hole transport material and the electron transport material are dissolved or dispersed in the solvent. Examples of the second solvent include aliphatic hydrocarbons (such as n-hexane, octane, and cyclohexane), aromatic hydrocarbons (such as benzene, toluene, and xylene), halogenated hydrocarbons (such as methylene chloride (dichloromethane), chloroform (trichloromethane), dichloroethane, carbon tetrachloride, and chlorobenzene), ethers (such as 1,3-dioxolane, dimethyl ether, diethyl ether, tetrahydrofuran, ethylene glycol dimethyl ether, and diethylene glycol dimethyl ether), ketones (such as acetone, methyl ethyl ketone, and cyclohexane), esters (such as ethyl acetate and methyl acetate), dimethyl formaldehyde, dimethylformamide, and dimethyl sulfoxide. Such solvents may be used alone or in combination of two or more (two, for instance) thereof. The second solvent is preferably methylene chloride, chloroform, tetrahydrofuran or 1,3-dioxolane, more preferably tetrahydrofuran.

The solvent in the coating liquid for photosensitive layer formation is preferably a solvent including methanol as the first solvent and tetrahydrofuran as the second solvent, more preferably a solvent including 20 parts by mass of methanol and 600 parts by mass of tetrahydrofuran.

(Charge Generating Agent)

Examples of the charge generating agent to be contained in the photosensitive layer include phthalocyanine pigments, perylene pigments, bisazo pigments, trisazo pigments, dithioketopyrrolopyrrole pigments, metal-free naphthalocyanine pigments, metal naphthalocyanine pigments, squaraine pigments, indigo pigments, azulenium pigments, cyanine pigments, powder of an inorganic photoconductive material (e.g., selenium, selenium-tellurium, selenium-arsenic, cadmium sulfide or amorphous silicon), pyrylium pigments, anthanthrone pigments, triphenylmethane pigments, indanthrene pigments, toluidine pigments, pyrazoline pigments, and quinacridone pigments. Such charge generating agents may be used alone or in combination of two or more thereof.

Exemplary phthalocyanine pigments include metal-free phthalocyanines and metallophthalocyanines. Examples of the metallophthalocyanines include titanyl phthalocyanine, hydroxygallium phthalocyanine, and chlorogallium phthalocyanine. Titanyl phthalocyanine is represented by Chemical Formula (CGM-1):

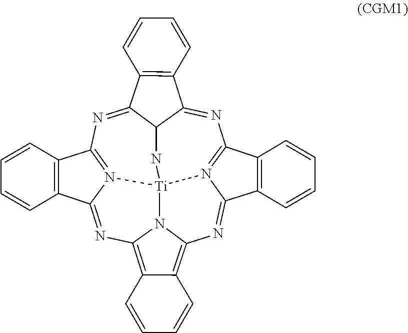

The phthalocyanine pigments may be crystalline or amorphous. Examples of crystalline metal-free phthalocyanines include a metal-free phthalocyanine crystal with an X-form structure (hereafter also referred to as “X-form metal-free phthalocyanine”).

Examples of crystalline titanyl phthalocyanines include titanyl phthalocyanine crystals with α-form, β-form, and Y-form structures (the crystals being hereafter also referred to as “α-form, β-form, and Y-form titanyl phthalocyanines,” respectively).

For a digital optical image forming apparatus (e.g., a laser beam printer or facsimile machine using such a light source as a semiconductor laser), for instance, it is preferable to use a photoreceptor sensitive to a wavelength range of 700 nm and more. The phthalocyanine pigments have high quantum yields in a wavelength range of 700 nm and more, so that, in that case, the charge generating agent is preferably a phthalocyanine pigment, more preferably a metal-free phthalocyanine or a titanyl phthalocyanine, and even more preferably an X-form metal-free phthalocyanine or a Y-form titanyl phthalocyanine, especially a Y-form titanyl phthalocyanine.

For the photoreceptor to be applied to an image forming apparatus using a short wavelength laser beam source (laser beam source with a wavelength of 350 to 550 nm, for instance), an anthanthrone pigment is suitably used.

The content of the charge generating agent in the coating liquid for photosensitive layer formation is preferably 0.1 to 50 parts by mass, more preferably 0.5 to 30 parts by mass, and even more preferably 0.5 to 4.5 parts by mass on 100 parts by mass of the binder resin contained in the coating liquid.

(Binder Resin)

The binder resin to be contained in the coating liquid for photosensitive layer formation includes a polyarylate resin (hereafter also referred to as “polyarylate resin (PA1)”) as a polymerized product of monomers including a first monomer represented by General Formula (1) below (hereafter also referred to as “monomer (1)”) and a second monomer represented by General Formula (2) below (hereafter also referred to as “monomer (2)”). In other words, the polyarylate resin (PA1) has a repeating unit derived from the monomer (1) and a repeating unit derived from the monomer (2).

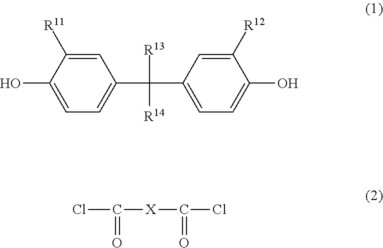

In General Formula (1), R¹¹ and R¹² each independently represent a hydrogen atom or an alkyl group with 1 to 4 carbon atoms. R¹³ and R¹⁴ each independently represent a hydrogen atom, an alkyl group with 1 to 4 carbon atoms or a phenyl group, or R¹³ and R¹⁴ are joined together to represent a divalent group represented by General Formula (Y) below. In General Formula (2), X represents a divalent group of Chemical Formula (X1), (X2), (X3) or (X4) below.

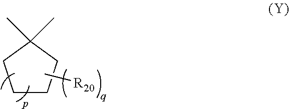

In General Formula (Y), R²⁰ represents a monovalent substituent. The letter p represents an integer between 1 and 6 inclusive. The letter q represents an integer between 0 and 5 inclusive.

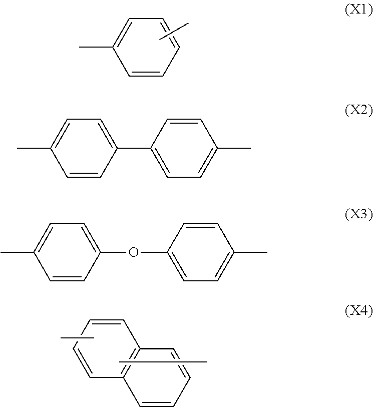

In the photoreceptor manufacturing method according to the first aspect of the present disclosure, the coating liquid for photosensitive layer formation, which contains a solvent including a lower alcohol and a binder resin including a polyarylate resin (PA1), is used to form a photosensitive layer, so as to form a photoreceptor allowing the suppression of a ghost image. A polyarylate resin (PA1) used as a binder resin for the photosensitive layer can improve the photoreceptor in abrasion resistance, while tending to make a ghost image easier to generate. The reason is presumed as follows.

In a polyarylate resin (PA1), the aromatic dicarboxylic acid dichloride (monomer (2)) as used as a raw material remains in an unreacted state. The aromatic dicarboxylic acid dichloride is thus contained indispensably in a photosensitive layer containing a polyarylate resin (PA1). The aromatic dicarboxylic acid dichloride as such is considered to inhibit the hole transfer in the photosensitive layer because it contains a chlorine atom with a high electronegativity. It is therefore presumed that the aromatic dicarboxylic acid dichloride increases holes remaining in the photosensitive layer after exposure and makes a ghost image easier to generate. In the photoreceptor manufacturing method according to the first aspect of the present disclosure, the coating liquid for photosensitive layer formation contains a lower alcohol. The lower alcohol reacts with the aromatic dicarboxylic acid dichloride between the preparation of the coating liquid for photosensitive layer formation and the application of the coating liquid. In addition, the lower alcohol possibly remaining in the formed photosensitive layer still reacts with the aromatic dicarboxylic acid dichloride. In the reaction of the aromatic dicarboxylic acid dichloride and the lower alcohol, hydrogen chloride and a dicarboxylic diester are produced, and the produced hydrogen chloride is volatilized out of the photosensitive layer. As a result, the aromatic dicarboxylic acid dichloride contained in the photosensitive layer is decreased, which is believed to result in a photoreceptor allowing the suppression of a ghost image. It should be noted that lower alcohols are generally not used for the formation of a photosensitive layer because the binder resin as typified by a polyarylate resin (PA1) is hard to dissolve in any such alcohols.

The alkyl group with 1 to 4 carbon atoms that is represented by R¹¹ and R¹² in General Formula (1) is preferably a methyl group or an ethyl group and more preferably a methyl group. Preferably, both R¹¹ and R¹² represent a hydrogen atom or a methyl group.

The alkyl group with 1 to 4 carbon atoms that is represented by R¹³ and R¹⁴ in General Formula (1) is preferably a methyl group or an ethyl group. It is preferable that one of R¹³ and R¹⁴ represents a methyl group and the other represents an ethyl group, or R¹³ and R¹⁴ are joined together to represent a divalent group represented by General Formula (Y).

Examples of the monovalent substituent as represented by R²⁰ in General Formula (Y) include a halogen atom, an alkyl group with 1 to 8 carbon atoms, and an aryl group with 6 to 14 carbon atoms.

In General Formula (Y), p preferably represents an integer between 1 and 3 inclusive, more preferably the integer 2. The letter q in the formula preferably represents 0.

The divalent group as represented by Chemical Formula (X4) is preferably a 1,4-naphthylene group or a 2,6-naphthylene group.

The monomer (1) preferably includes the compound as represented by Chemical Formula (1-1) or (1-2) below (the compounds of the formulae being hereafter also referred to as “monomers (1-1) and (1-2),” respectively).

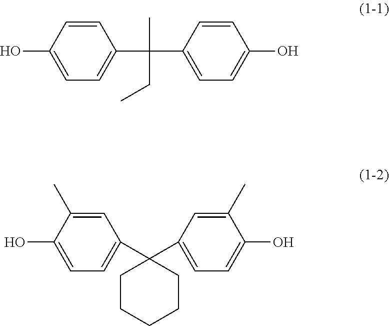 [SMILES: CCC(C)(c1ccc(O)cc1)c1ccc(O)cc1 ; Cc1cc(C2(c3ccc(O)c(C)c3)CCCCC2)ccc1O]

In the polyarylate resin (PA1), the ratio of the substance quantity of the repeating units derived from the monomers (1) and (2) to the substance quantity of all the repeating units (the substance quantity of the repeating units derived from the monomers (1) and (2)/the substance quantity of all the repeating units) is preferably 0.70 or more, more preferably 0.90 or more, and even more preferably 1.00. Also in the polyarylate resin (PA1), the ratio of the substance quantity of the repeating unit derived from the monomer (1) to the substance quantity of the repeating units derived from the monomers (1) and (2) (the substance quantity of the repeating unit derived from the monomer (1)/the substance quantity of the repeating units derived from the monomers (1) and (2)) is preferably 0.45 to 0.55.

The number of a repeating unit possessed by a polyarylate resin (PA1) is not defined herein as a number determined from one molecular chain but as the mean of numbers determined from the entire polyarylate resin (PA1) (multiple molecular chains thereof) in a photosensitive layer. The number of each repeating unit can be calculated from the ¹H-NMR spectrum of the polyarylate resin (PA1) that is measured using a proton nuclear magnetic resonance spectrometer.

The polyarylate resin (PA1) preferably has, as its repeating unit, at least one of the repeating units as represented by Chemical Formulae (r-1) through (r-7) below (hereafter also referred to as “repeating units (r-1) through (r-7),” respectively). More preferably, the polyarylate resin (PA1) has two or more (two, for instance) of the repeating units (r-1) through (r-7) as its repeating units.

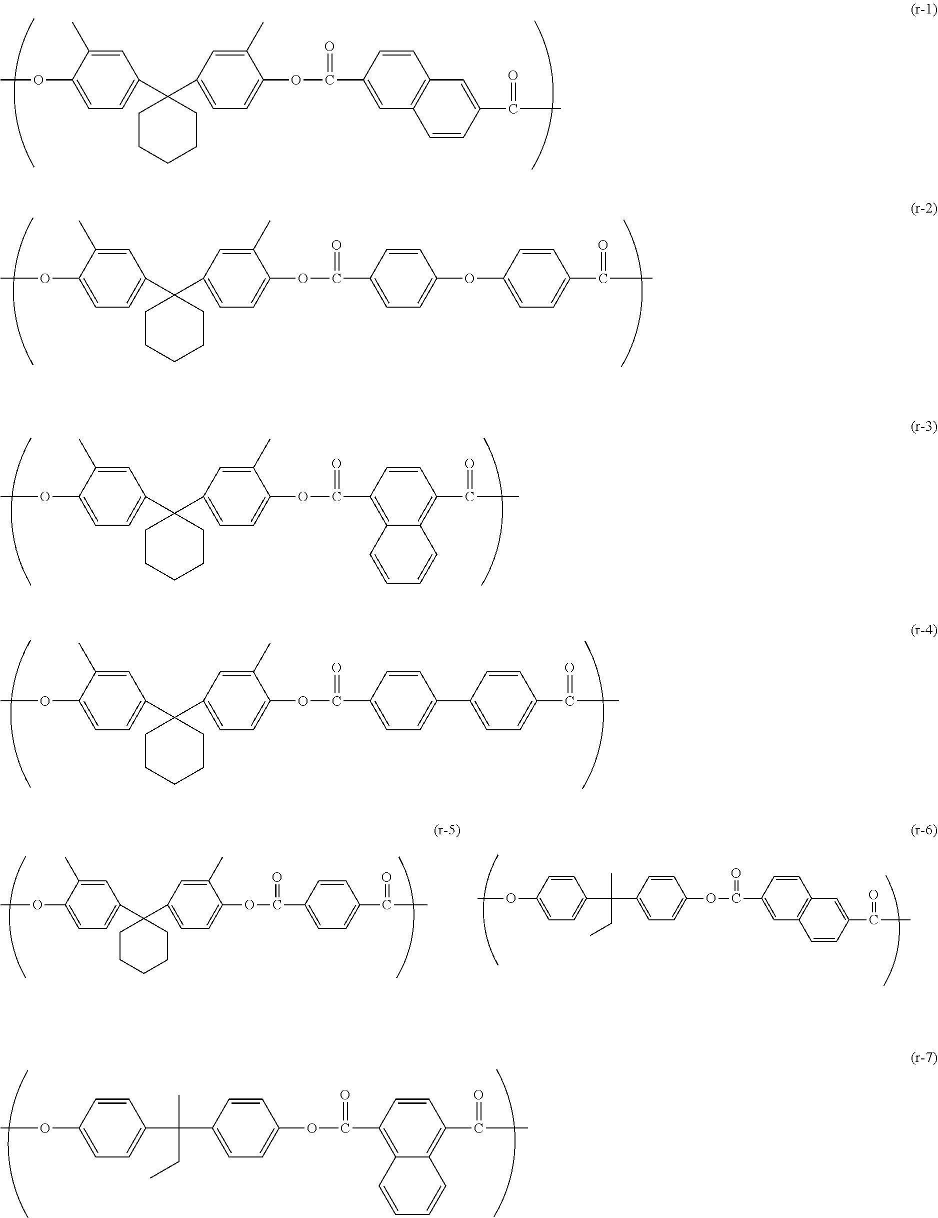

The polyarylate resin (PA1) is preferably:
a resin having the repeating unit (r-1) and the repeating unit (r-2);
a resin having the repeating unit (r-1) and the repeating unit (r-3);
a resin having the repeating unit (r-1) and the repeating unit (r-4);
a resin having the repeating unit (r-1) and the repeating unit (r-5);
a resin having the repeating unit (r-6) and the repeating unit (r-7); or
a resin having the repeating unit (r-6) and the repeating unit (r-2).

Preferred as the polyarylate resin (PA1) are the polyarylate resins as represented by Chemical Formulae (R-1) through (R-6) below (hereafter also referred to as “polyarylate resins (R-1) through (R-6),” respectively). In Chemical Formulae (R-1) through (R-6) below, the Arabic numeral at the lower right of each repeating unit indicates the proportion (percentage) of the substance quantity of the relevant repeating unit with respect to the substance quantity of all the repeating units of the polyarylate resin (PA1). The polyarylate resins (R-1) through (R-6) may each be any of a random copolymer, a block copolymer, a periodic copolymer and an alternating copolymer.

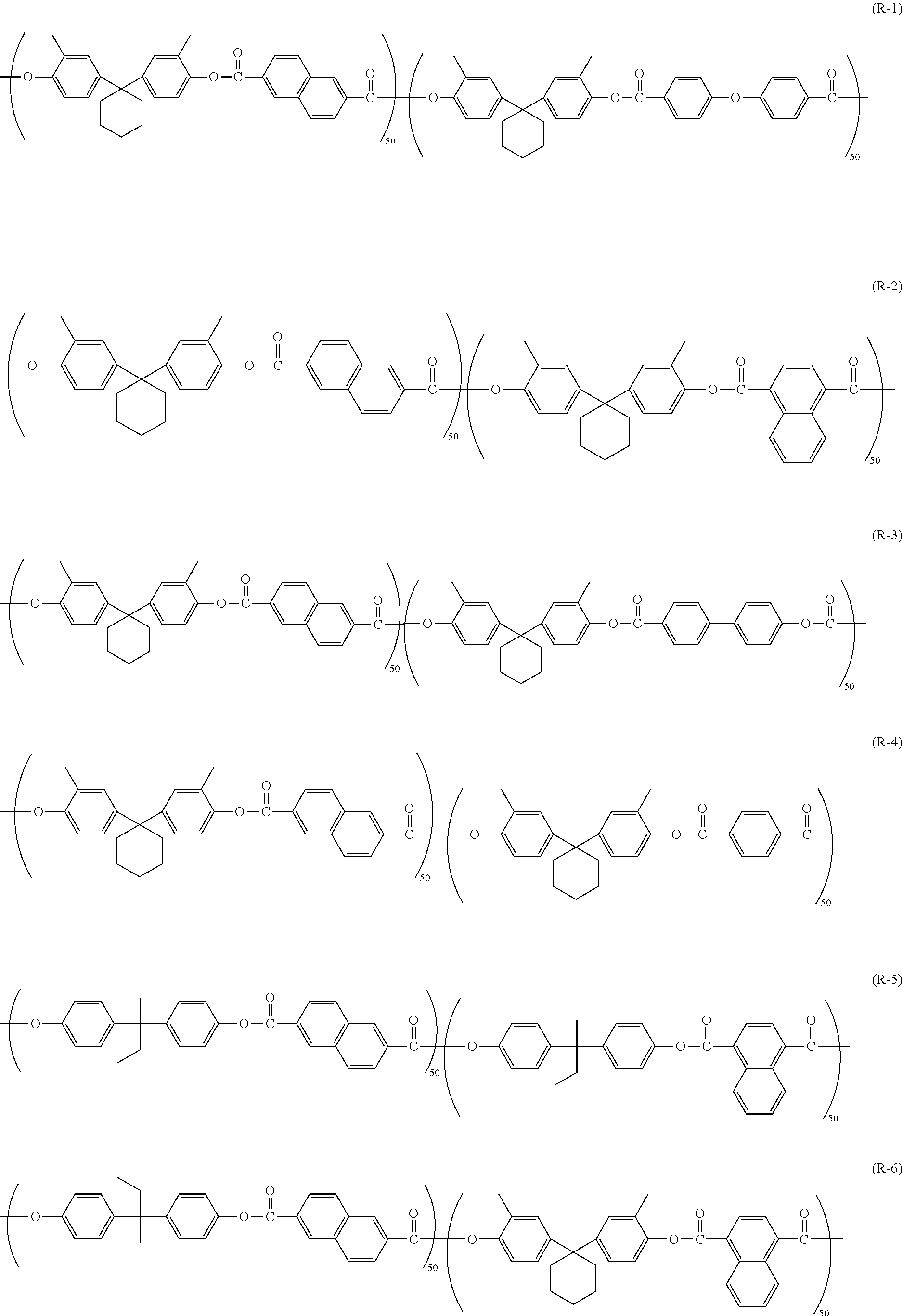

The viscosity average molecular weight of the polyarylate resin (PA1) is preferably 10,000 or more, more preferably 20,000 or more, and still more preferably 30,000 or more, especially 40,000 or more. If the polyarylate resin (PA1) has a viscosity average molecular weight of 10,000 or more, the abrasion resistance of the photoreceptor to be formed is improved. On the other hand, the viscosity average molecular weight of the polyarylate resin (PA1) is preferably not more than 80,000 and more preferably not more than 70,000. If the viscosity average molecular weight of the polyarylate resin (PA1) is not more than 80,000, the polyarylate resin (PA1) is easy to dissolve in the solvent for the coating liquid for photosensitive layer formation and facilitates the formation of the photosensitive layer.

The method of preparing the polyarylate resin (PA1) is not particularly limited, with examples thereof including polycondensation of the monomers (1) and (2). As a method of polycondensation, known synthesis methods (to be more specific, solution polymerization, melt polymerization and interfacial polymerization, for instance) may be employed. The polyarylate resin (PA1) may include, apart from the monomer (1) as above, another aromatic diol or aromatic diacetate. In addition, the polyarylate resin (PA1) may include, apart from the monomer (2) as above, another aromatic dicarboxylic acid dichloride, aromatic dicarboxylic acid, aromatic dimethyl dicarboxylate ester, aromatic diethyl dicarboxylate ester and aromatic dicarboxylic anhydride.

During the polycondensation of the monomers (1) and (2), one or both of a base and a catalyst may be added. The base and the catalyst may appropriately be selected from known bases and catalysts. Examples of the base include sodium hydroxide. Examples of the catalyst include benzyltributyl ammonium chloride, ammonium chloride, ammonium bromide, quaternary ammonium salts, triethylamine, and trimethylamine.

While it is preferable that the binder resin includes the polyarylate resin (PA1) alone, a resin other than the polyarylate resin (PA1) may additionally be included in the binder resin. The content ratio of the polyarylate resin (PA1) with respect to the mass of the binder resin is preferably 80% by mass or more, more preferably 90% by mass or more, and even more preferably 100% by mass.

Examples of the resin which may be included in the binder resin include a thermoplastic resin, a heat-curable resin, and a photocurable resin. Exemplary thermoplastic resins include a polycarbonate resin, a polyarylate resin other than the polyarylate resin (PA1), a styrene-butadiene copolymer, a styrene-acrylonitrile copolymer, a styrene-maleic acid copolymer, a polyacrylic acid, a styrene-acrylic acid copolymer, a polyethylene resin, an ethylene-vinyl acetate copolymer, a chlorinated polyethylene resin, a polyvinyl chloride resin, a polypropylene resin, an ionomer resin, a vinyl chloride-vinyl acetate copolymer, an alkyd resin, a polyamide resin, a urethane resin, a polysulfone resin, a diallyl phthalate resin, a ketone resin, a polyvinyl butyral resin, a polyester resin, a polyvinyl acetal resin, and a polyether resin. Exemplary heat-curable resins include a silicone resin, an epoxy resin, a phenol resin, a urea resin, and a melamine resin. Exemplary photocurable resins include an acrylic acid adduct of an epoxy compound and an acrylic acid adduct of a urethane compound. Such other resins may be used alone or in combination of two or more thereof.

(Hole Transport Material)

Examples of the hole transport material to be contained in the coating liquid for photosensitive layer formation include a triphenylamine derivative, a diamine derivative (e.g., N,N,N′,N′-tetraphenylbenzidine derivative, N,N,N′,N′-tetraphenylphenylenediamine derivative, N,N,N′,N′-tetraphenylnaphthylenediamine derivative, N,N,N′,N′-tetraphenylphenanthrylenediamine derivative or di(aminophenylethenyl)benzene derivative), an oxadiazole-based compound (e.g., 2,5-di(4-methylaminophenyl)-1,3,4-oxadiazole)), a styryl-based compound (e.g., 9-(4-diethylaminostyryl)anthracene), a carbazole-based compound (e.g., polyvinyl carbazole), an organic polysilane compound, a pyrazoline-based compound (e.g., 1-phenyl-3-(p-dimethylaminophenyl)pyrazoline), a hydrazone-based compound, an indole-based compound, an oxazole-based compound, an isoxazole-based compound, a thiazole-based compound, a thiadiazole-based compound, an imidazole-based compound, a pyrazole-based compound, and a triazole-based compound. Such hole transport materials may be used alone or in combination of two or more thereof.

From the viewpoint of forming a photoreceptor allowing a more effective suppression of a ghost image, the preferred hole transport material is the compound as represented by General Formula (11), (12), (13) or (14) below (the compounds of the formulae being hereafter also referred to as “hole transport materials (11), (12), (13) and (14),” respectively).

The hole transport material (11) is represented by General Formula (11):

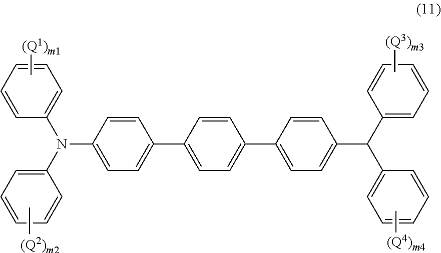

In General Formula (11), Q¹ through Q⁴ each independently represent an alkyl group with 1 to 8 carbon atoms, a phenyl group or an alkoxy group with 1 to 8 carbon atoms. The signs m1 through m4 each independently represent an integer between 0 and 2 inclusive.

If m1 represents 2 in General Formula (11), a plurality of Q¹s may be the same or different from each other. If m2 represents 2, a plurality of Q^{t}s may be the same or different from each other. If m3 represents 2, a plurality of Q³s may be the same or different from each other. If m4 represents 2, a plurality of Q⁴s may be the same or different from each other.

Preferably, Q¹ and Q³ in General Formula (11) each independently represent an alkyl group with 1 to 4 carbon atoms or an alkoxy group with 1 to 4 carbon atoms, more preferably a methyl group or a methoxy group.

Preferably, Q² and Q⁴ in General Formula (11) each independently represent an alkyl group with 1 to 4 carbon atoms, more preferably an ethyl group.

Preferably, m1 and m3 in General Formula (11) each represent 1. Preferably, m2 and m4 each independently represent 0 or 1.

It is desirable that, in General Formula (11), Q¹ and Q³ each independently represent an alkyl group with 1 to 4 carbon atoms or an alkoxy group with 1 to 4 carbon atoms, Q² and Q⁴ each independently represent an alkyl group with 1 to 4 carbon atoms, m1 and m3 each represent 1, and m2 and m4 each independently represent 0 or 1.

Preferred examples of the hole transport material (11) include the hole transport materials as represented by Chemical Formulae (11-H1), (11-H2) and (11-H3) below (hereafter also referred to as “hole transport materials (11-H1), (11-H2) and (11-H3),” respectively).

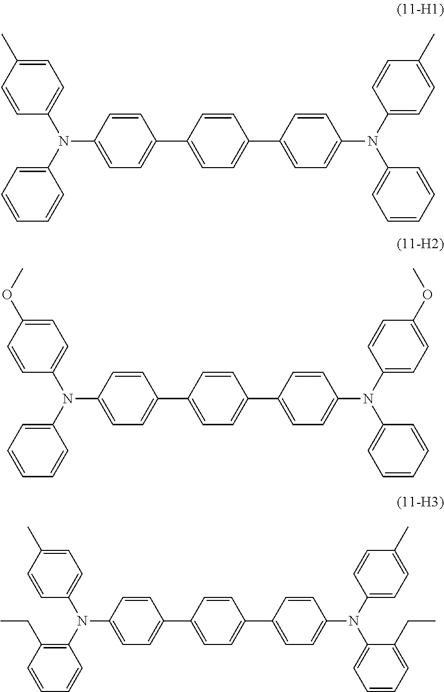

The hole transport material (12) is represented by General Formula (12):

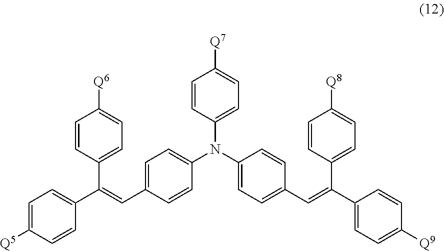

In General Formula (12), Q⁵ through Q⁹ each independently represent a hydrogen atom, an alkyl group with 1 to 8 carbon atoms, a phenyl group or an alkoxy group with 1 to 8 carbon atoms.

Q⁵ and Q⁹ in General Formula (12) are preferably the same. Q⁶ and Q⁸ are preferably the same. It is preferable moreover that Q⁵ through Q⁹ are the same.

Preferably, Q⁵ through Q⁹ in General Formula (12) each independently represent an alkyl group with 1 to 4 carbon atoms, more preferably a methyl group.

Preferred examples of the hole transport material (12) include the compound as represented by Chemical Formula (12-H5) below (hereafter also referred to as “hole transport material (12-H5)”).

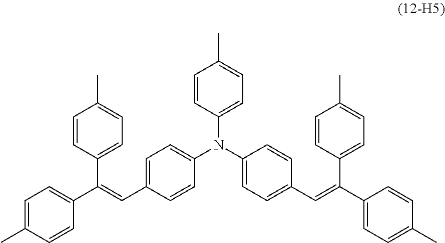

The hole transport material (13) is represented by General Formula (13):

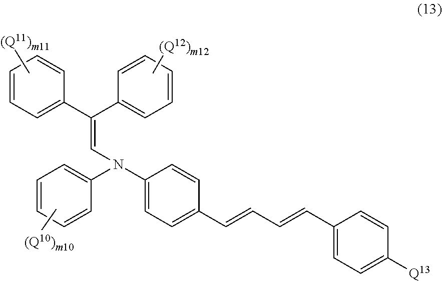

In General Formula (13), Q¹⁰ through Q¹² each independently represent an alkyl group with 1 to 8 carbon atoms, a phenyl group or an alkoxy group with 1 to 8 carbon atoms. Q¹³ represents a hydrogen atom, an alkyl group with 1 to 8 carbon atoms, a phenyl group or an alkoxy group with 1 to 8 carbon atoms. The signs m10 through m12 each independently represent an integer between 0 and 2 inclusive. If m10 represents 2 in General Formula (13), a plurality of Q¹⁰s may be the same or different from each other. If m11 represents 2, a plurality of G¹¹s may be the same or different from each other. If m12 represents 2, a plurality of Q¹²s may be the same or different from each other.

Preferably, m10 through m12 in General Formula (13) each represent 0. Preferably, Q¹³ represents a hydrogen atom. It is more preferable that m10 through m12 each represent 0 and, at the same time, Q¹³ represents a hydrogen atom.

Preferred examples of the hole transport material (13) include the compound as represented by Chemical Formula (13-H4) below (hereafter also referred to as “hole transport material (13-H4)”).

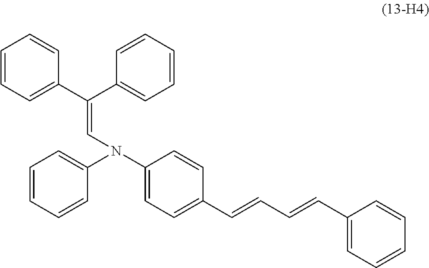 [SMILES: C(=C(c1ccccc1)c1ccccc1)N(c1ccccc1)c1ccc(/C=C/C=C/c2ccccc2)cc1]

The hole transport material (14) is represented by General Formula (14):

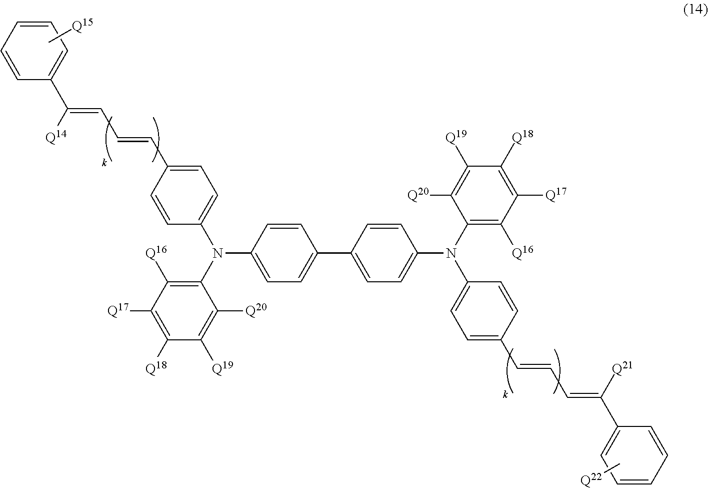

In General Formula (14), Q¹⁴ through Q²² each independently represent a hydrogen atom, an alkyl group with 1 to 8 carbon atoms, a phenyl group or an alkoxy group with 1 to 8 carbon atoms. The letter k represents 0 or 1.

In General Formula (14), two Q¹⁶s may be the same or different from each other and are preferably the same. Two Q¹⁷s may be the same or different from each other and are preferably the same. Two Q¹⁸s may be the same or different from each other and are preferably the same. Two Q¹⁹s may be the same or different from each other and are preferably the same. Two Q²⁰s may be the same or different from each other and are preferably the same. Two ks may be the same or different from each other and are preferably the same.

In General Formula (14), Q¹⁴ and Q²¹ are preferably the same. Q¹⁵ and Q²² are preferably the same.

Preferably, Q¹⁴, Q¹⁵, Q¹⁷, Q¹⁸, Q¹⁹, Q²¹ and Q²² in General Formula (14) each represent a hydrogen atom.

Preferably, Q¹⁶ and Q²⁰ in General Formula (14) each independently represent an alkyl group with 1 to 4 carbon atoms, more preferably a methyl group or an ethyl group. It is even more preferable that one of Q¹⁶ and Q²⁰ represents a methyl group and the other represents an ethyl group.

It is desirable that, in General Formula (14), Q¹⁴, Q¹⁵, Q¹⁷, Q¹⁸, Q¹⁹, Q²¹ and Q²² each represent a hydrogen atom, and Q¹⁶ and Q²⁰ each independently represent an alkyl group with 1 to 4 carbon atoms.

Preferred examples of the hole transport material (14) include the compounds as represented by Chemical Formulae (14-H6) and (14-H7) below (hereafter also referred to as “hole transport materials (14-H6) and (14-H7),” respectively).

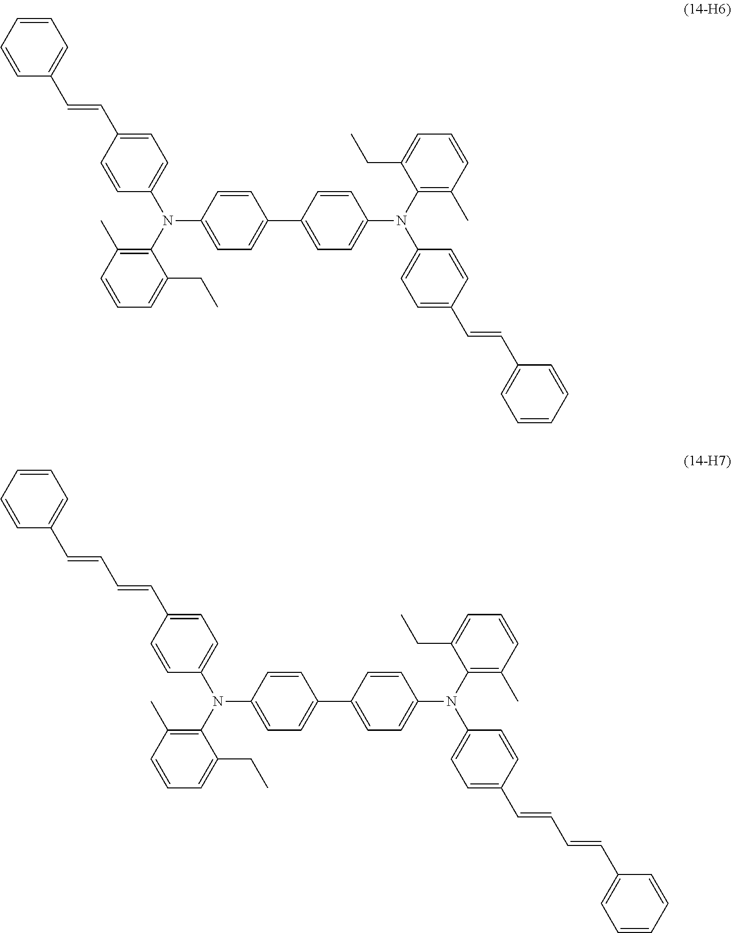 [SMILES: CCc1cccc(C)c1N(c1ccc(/C=C/c2ccccc2)cc1)c1ccc(-c2ccc(N(c3ccc(/C=C/c4ccccc4)cc3)c3c(C)cccc3CC)cc2)cc1 ; CCc1cccc(C)c1N(c1ccc(/C=C/C=C/c2ccccc2)cc1)c1ccc(-c2ccc(N(c3ccc(/C=C/C=C/c4ccccc4)cc3)c3c(C)cccc3CC)cc2)cc1]

The coating liquid for photosensitive layer formation may contain, as a hole transport material, the hole transport material (11), (12), (13) or (14) alone or along with another hole transport material. The content ratio of the hole transport material (11), (12), (13) or (14) with respect to the total hole transport material is preferably 80% by mass or more, more preferably 90% by mass or more, and even more preferably 100% by mass.

The content of the hole transport material in the coating liquid for photosensitive layer formation is preferably 10 to 200 parts by mass, more preferably 20 to 100 parts by mass on 100 parts by mass of the binder resin.

Electron Transport Material

The coating liquid for photosensitive layer formation contains, as an electron transport material, the compound as represented by General Formula (31), (32), (33) or (34) below (the compounds of the formulae being hereafter also referred to as “electron transport materials (31), (32), (33) and (34),” respectively).

The electron transport material (31) is represented by General Formula (31):

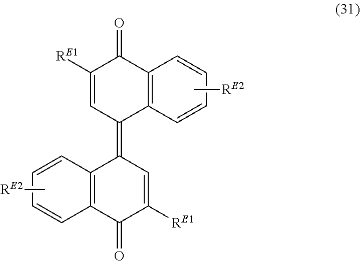

In General Formula (31), R^{E1} and R^{E2} each independently represent a hydrogen atom, an alkyl group with 1 to 8 carbon atoms, a phenyl group or an alkoxy group with 1 to 8 carbon atoms. Two R^{E1} s in the formula may be the same or different from each other. Two R^{E2}s in the formula may be the same or different from each other.

In General Formula (31), the two R^{E1} s are preferably the same. The two R^{E2}s are preferably the same.

Preferably, the R^{E1} s in General Formula (31) each represent an alkyl group with 1 to 8 carbon atoms, more preferably an alkyl group with 4 to 6 carbon atoms, and even more preferably a tert-pentyl group.

Preferably, the R^{E2}s in General Formula (31) each represent a hydrogen atom.

Preferred examples of the electron transport material (31) include the compound as represented by Chemical Formula (E-1) below (hereafter also referred to as “electron transport material (E-1)”).

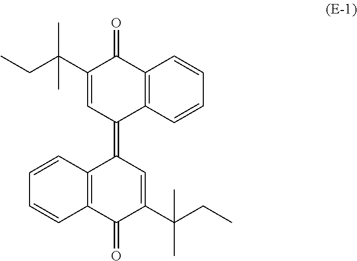 [SMILES: CCC(C)(C)C1=C/C(=C2/C=C(C(C)(C)CC)C(=O)c3ccccc32)c2ccccc2C1=O]

The electron transport material (32) is represented by General Formula (32):

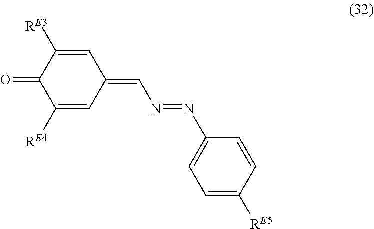

In General Formula (32), R^{E3} and R^{E4} each independently represent a hydrogen atom, an alkyl group with 1 to 8 carbon atoms, a phenyl group or an alkoxy group with 1 to 8 carbon atoms. R^{E5} represents a hydrogen atom, a halogen atom, an alkyl group with 1 to 8 carbon atoms, a phenyl group or an alkoxy group with 1 to 8 carbon atoms.

In General Formula (32), R^{E3} and R^{E4} are preferably the same.

Preferably, R^{E3} and R^{E4} in General Formula (32) each independently represent an alkyl group with 1 to 8 carbon atoms, more preferably an alkyl group with 1 to 4 carbon atoms, and even more preferably a tert-butyl group.

Preferably, R^{E5} in General Formula (32) represents a halogen atom, more preferably a chlorine atom.

Preferred examples of the electron transport material (32) include the compound as represented by Chemical Formula (E-2) below (hereafter also referred to as “electron transport material (E-2)”).

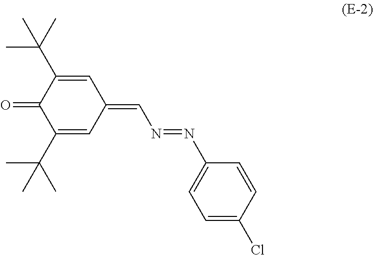 [SMILES: CC(C)(C)C1=CC(=C/N=N/c2ccc(Cl)cc2)C=C(C(C)(C)C)C1=O]

The electron transport material (33) is represented by General Formula (33):

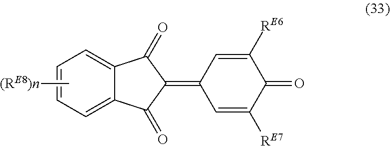

In General Formula (33), R^{E6} and R^{E7} each independently represent a hydrogen atom, an alkyl group with 1 to 8 carbon atoms, a phenyl group or an alkoxy group with 1 to 8 carbon atoms. R^{E8} represents an alkyl group with 1 to 8 carbon atoms, a phenyl group or an alkoxy group with 1 to 8 carbon atoms. The letter n represents an integer between 0 to 4 inclusive. A plurality of R^{E8}s in the formula may be the same or different from one another if n represents an integer that is 2 or higher.

In General Formula (33), R^{E6} and R^{E7} are preferably the same.

Preferably, R^{E6} and R^{E7} in General Formula (33) each independently represent an alkyl group with 1 to 8 carbon atoms, more preferably an alkyl group with 1 to 4 carbon atoms, and even more preferably a methyl group.

Preferably, R^{E8} in General Formula (33) represents an alkyl group with 1 to 8 carbon atoms, more preferably an alkyl group with 1 to 4 carbon atoms, and even more preferably an n-butyl group.

Preferably, n in General Formula (33) represents an integer between 0 and 2 inclusive, more preferably the integer 1.

Preferred examples of the electron transport material (33) include the compound as represented by Chemical Formula (E-3) below (hereafter also referred to as “electron transport material (E-3)”).

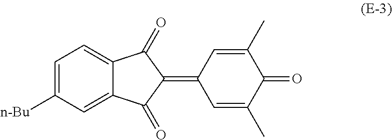

The electron transport material (34) is represented by General Formula (34):

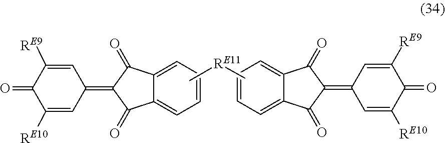

In General Formula (34), R^{E9} and R^{E10} each independently represent a hydrogen atom, an alkyl group with 1 to 8 carbon atoms, a phenyl group or an alkoxy group with 1 to 8 carbon atoms. R^{E11} represents a single bond or an alkanediyl group with 1 to 8 carbon atoms. Two R^{E9}s in the formula may be the same or different from each other. Two R^{E10}s in the formula may be the same or different from each other.

In General Formula (34), the two R^{E9}s are preferably the same. The two R^{E10}s are preferably the same. It is preferable moreover that R^{E9} and R^{E10} are the same.

Preferably, R^{E9} and R^{E10} in General Formula (34) each independently represent an alkyl group with 1 to 8 carbon atoms, more preferably an alkyl group with 1 to 4 carbon atoms, and even more preferably a tert-butyl group.

Preferably, R^{E11} in General Formula (34) represents a single bond.

Preferred examples of the electron transport material (34) include the compound as represented by Chemical Formula (E-4) below (hereafter also referred to as “electron transport material (E-4)”).

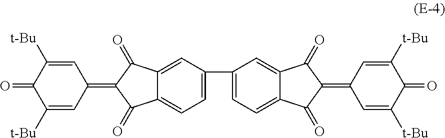 [SMILES: CC(C)(C)C1=CC(=C2C(=O)c3ccc(-c4ccc5c(c4)C(=O)C(=C4C=C(C(C)(C)C)C(=O)C(C(C)(C)C)=C4)C5=O)cc3C2=O)C=C(C(C)(C)C)C1=O]

It is preferable that the coating liquid for photosensitive layer formation only contains any of the electron transport materials (31) through (34) as an electron transport material, while an electron transport material other than the electron transport materials (31) through (34) (hereafter also referred to as “another electron transport material”) may additionally be contained in the coating liquid. The content ratio of any of the electron transport materials (31) through (34) with respect to the total electron transport material is preferably 80% by mass or more, more preferably 90% by mass or more, and even more preferably 100% by mass.

Examples of another electron transport material include a quinone-based compound, a diimide-based compound, a hydrazone-based compound, a malononitrile-based compound, a thiopyran-based compound, a trinitrothioxanthone-based compound, a 3,4,5,7-tetranitro-9-fluorenone-based compound, a dinitroanthracene-based compound, a dinitroacridine-based compound, tetracyanoethylene, 2,4,8-trinitrothioxanthone, dinitrobenzene, dinitroacidine, succinic anhydride, maleic anhydride, and dibromomaleic anhydride. Exemplary quinone-based compounds include a diphenoquinone-based compound, an azoquinone-based compound, an anthraquinone-based compound, a naphthoquinone-based compound, a nitroanthraquinone-based compound, and a dinitroanthraquinone-based compound. Such another electron transport material may be used alone or in combination of two or more thereof.

The content of the electron transport material in the coating liquid for photosensitive layer formation is preferably 20 to 120 parts by mass, more preferably 20 to 100 parts by mass, and even more preferably 40 to 90 parts by mass, especially 60 to 90 parts by mass on 100 parts by mass of the binder resin.

(Additives)

Examples of the additives, which the coating liquid for photosensitive layer formation may contain, include an antidegradant (e.g., an antioxidant, a radical scavenger, a singlet quencher or an ultraviolet absorber), a softener, a surface modifier, a filler, a thickener, a dispersion stabilizer, a wax, an acceptor (e.g., an electron acceptor), a donor, a surfactant, a plasticizer, a sensitizer, and a leveling agent. Examples of the antioxidant include a hindered phenol (e.g., di(tert-butyl) p-cresol), a hindered amine, paraphenylenediamine, arylalkane, hydroquinone, spirochroman, spiroindanone, and derivatives thereof. Organic sulfur compounds and organic phosphorus compounds may also be used as an antioxidant. Dimethyl silicone oil may be mentioned as a leveling agent. The sensitizer may be metaterphenyl.

If the coating liquid for photosensitive layer formation contains an additive, the additive content of the coating liquid is preferably 0.1 to 20 parts by mass and more preferably 1 to 5 parts by mass on 100 parts by mass of the binder resin.

(Combination)

Preferred as the combination of the binder resin, the hole transport material and the electron transport material to be contained in the coating liquid for photosensitive layer formation are Combinations (k-1) through (k-15) as set forth in Table 1 below. In Table 1, H-1 through H-7 in the “Hole transport material” column designate the hole transport materials (11-H1), (11-H2), (11-H3), (13-H4), (12-H5), (14-H6) and (14-H7), respectively.

TABLE 1

| | Binder | Hole | Electron |
|---|---|---|---|
| Combination | resin | transport material | transport material |
| k-1 | R-1 | H-1 | E-1 |
| k-2 | R-2 | H-1 | E-1 |
| k-3 | R-3 | H-1 | E-1 |
| k-4 | R-4 | H-1 | E-1 |
| k-5 | R-5 | H-1 | E-1 |
| k-6 | R-6 | H-1 | E-1 |
| k-7 | R-1 | H-2 | E-1 |
| k-8 | R-1 | H-3 | E-1 |
| k-9 | R-1 | H-4 | E-1 |
| k-10 | R-1 | H-5 | E-1 |
| k-11 | R-1 | H-6 | E-1 |
| k-12 | R-1 | H-7 | E-1 |
| k-13 | R-1 | H-1 | E-2 |
| k-14 | R-1 | H-1 | E-3 |
| k-15 | R-1 | H-1 | E-4 |

The photoreceptor manufacturing method may include formation of an intermediate layer, as required. The method to be used to form an intermediate layer may be a known method selected as appropriate.

(Second Aspect: Coating Liquid for Photosensitive Layer Formation)

The coating liquid for photosensitive layer formation according to a second aspect of the present disclosure is a coating liquid for photosensitive layer formation that is used to form a single-layered photosensitive layer of an electrographic photoreceptor, and contains a solvent, a charge generating agent, a binder resin, a hole transport material, and an electron transport material. The solvent includes a first solvent as an alcohol with 1 to 3 carbon atoms and a second solvent as a solvent other than the first solvent. The binder resin includes a polyarylate resin having a first repeating unit represented by General Formula (20) below and a second repeating unit represented by General Formula (21) below (hereafter also referred to as “polyarylate resin (PA2)”). The electron transport material includes a compound represented by General Formula (31), (32), (33) or (34) below.

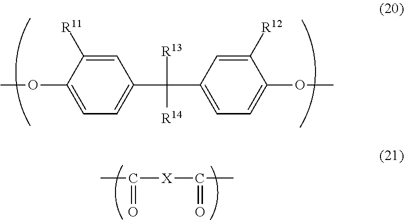

In General Formula (20), R¹¹ and R¹² each independently represent a hydrogen atom or an alkyl group with 1 to 4 carbon atoms. R¹³ and R¹⁴ each independently represent a hydrogen atom, an alkyl group with 1 to 4 carbon atoms or a phenyl group, or R¹³ and R¹⁴ are joined together to represent a divalent group represented by General Formula (Y) below. In General Formula (21), X represents a divalent group represented by Chemical Formula (X1), (X2), (X3) or (X4) below.

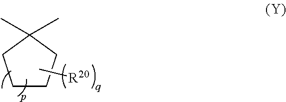

In General Formula (Y), R²⁰ represents a monovalent substituent. The letter p represents an integer between 1 and 6 inclusive. The letter q represents an integer between 0 and 5 inclusive.

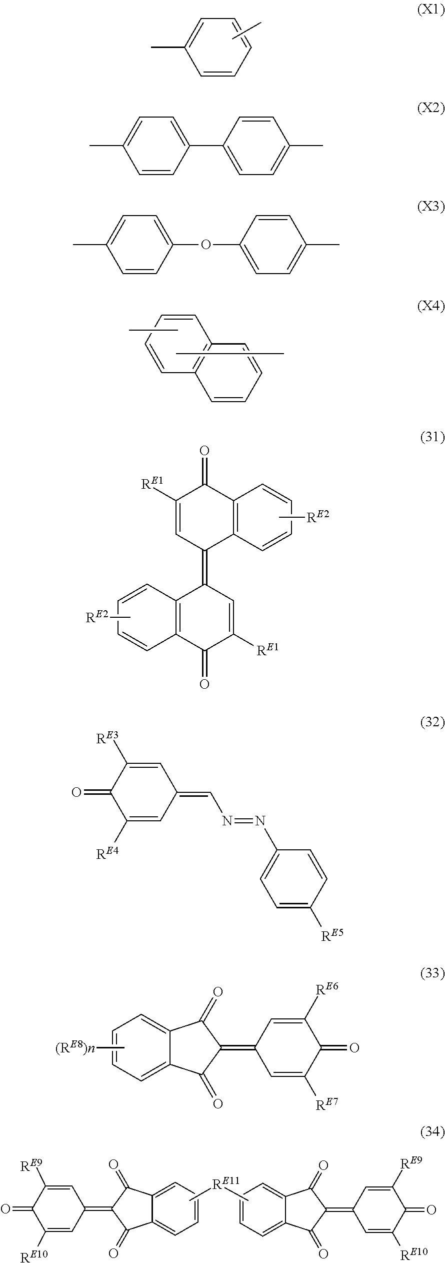

In General Formula (31), R^{E1} and R^{E2} each independently represent a hydrogen atom, an alkyl group with 1 to 8 carbon atoms, a phenyl group or an alkoxy group with 1 to 8 carbon atoms. Two R^{E1}s in the formula may be the same or different from each other. Two R^{E2}s in the formula may be the same or different from each other.

In General Formula (32), R^{E3} and R^{E4} each independently represent a hydrogen atom, an alkyl group with 1 to 8 carbon atoms, a phenyl group or an alkoxy group with 1 to 8 carbon atoms. R^{E5} represents a hydrogen atom, a halogen atom, an alkyl group with 1 to 8 carbon atoms, a phenyl group or an alkoxy group with 1 to 8 carbon atoms.

In General Formula (33), R^{E6} and R^{E7} each independently represent a hydrogen atom, an alkyl group with 1 to 8 carbon atoms, a phenyl group or an alkoxy group with 1 to 8 carbon atoms. R^{E8} represents an alkyl group with 1 to 8 carbon atoms, a phenyl group or an alkoxy group with 1 to 8 carbon atoms. The letter n represents an integer between 0 to 4 inclusive. A plurality of R^{E8}s in the formula may be the same or different from one another if n represents an integer that is 2 or higher.

In General Formula (34), R^{E9} and R^{E10} each independently represent a hydrogen atom, an alkyl group with 1 to 8 carbon atoms, a phenyl group or an alkoxy group with 1 to 8 carbon atoms. R^{E11} represents a single bond or an alkanediyl group with 1 to 8 carbon atoms. Two R^{E9}s in the formula may be the same or different from each other. Two R^{E11}s in the formula may be the same or different from each other.

The details of the coating liquid for photosensitive layer formation according to the second aspect are the same as those of the coating liquid for photosensitive layer formation to be used in the photoreceptor manufacturing method according to the first aspect. The polyarylate resin (PA2) is the same as the polyarylate resin (PA1) as described in association with the first aspect. Consequently, the description on R¹¹ through R¹⁴, X, R²⁰, p and q in General Formulae (20), (21) and (Y) that is made in association with the second aspect is the same as that on R¹¹ through R¹⁴, X, R²⁰, p and q in General Formulae (1), (2) and (Y) that is made in association with the first aspect.

(Third Aspect: Electrographic Photoreceptor)

The photoreceptor according to a third aspect of the present disclosure is provided with a conductive substrate and a photosensitive layer. The photosensitive layer is formed as a single layer, and contains an alcohol with 1 to 3 carbon atoms (lower alcohol), a charge generating agent, a binder resin, a hole transport material, and an electron transport material. The binder resin includes a polyarylate resin having a first repeating unit represented by General Formula (20) below and a second repeating unit represented by General Formula (21) below (hereafter also referred to as “polyarylate resin (PA2)”). The electron transport material includes a compound represented by General Formula (31), (32), (33) or (34) below.

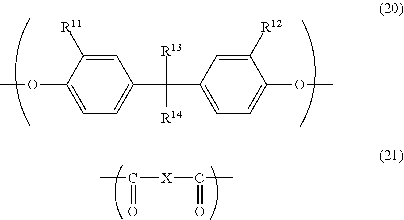

In General Formula (20), R¹¹ and R¹² each independently represent a hydrogen atom or an alkyl group with 1 to 4 carbon atoms. R¹³ and R¹⁴ each independently represent a hydrogen atom, an alkyl group with 1 to 4 carbon atoms or a phenyl group, or R¹³ and R¹⁴ are joined together to represent a divalent group represented by General Formula (Y) below. In General Formula (21), X represents a divalent group represented by Chemical Formula (X1), (X2), (X3) or (X4) below.

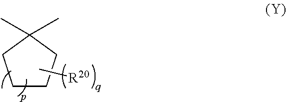

In General Formula (Y), R²⁰ represents a monovalent substituent. The letter p represents an integer between 1 and 6 inclusive. The letter q represents an integer between 0 and 5 inclusive.

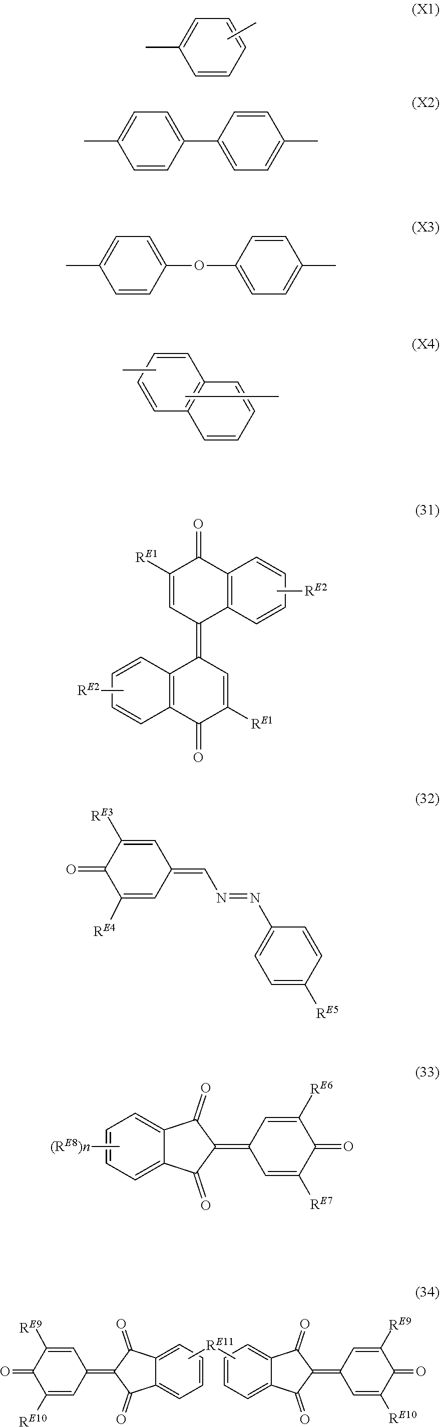

In General Formula (31), R^{E1} and R^{E2} each independently represent a hydrogen atom, an alkyl group with 1 to 8 carbon atoms, a phenyl group or an alkoxy group with 1 to 8 carbon atoms. Two R^{E1} s in the formula may be the same or different from each other. Two R^{E2}s in the formula may be the same or different from each other.

In General Formula (32), R^{E3} and R^{E4} each independently represent a hydrogen atom, an alkyl group with 1 to 8 carbon atoms, a phenyl group or an alkoxy group with 1 to 8 carbon atoms. R^{E5} represents a hydrogen atom, a halogen atom, an alkyl group with 1 to 8 carbon atoms, a phenyl group or an alkoxy group with 1 to 8 carbon atoms.

In General Formula (33), R^{E6} and R^{E7} each independently represent a hydrogen atom, an alkyl group with 1 to 8 carbon atoms, a phenyl group or an alkoxy group with 1 to 8 carbon atoms. R^{E8} represents an alkyl group with 1 to 8 carbon atoms, a phenyl group or an alkoxy group with 1 to 8 carbon atoms. The letter n represents an integer between 0 to 4 inclusive. A plurality of R^{E8}s in the formula may be the same or different from one another if n represents an integer that is 2 or higher.

In General Formula (34), R^{E9} and R^{E10} each independently represent a hydrogen atom, an alkyl group with 1 to 8 carbon atoms, a phenyl group or an alkoxy group with 1 to 8 carbon atoms. R^{E11} represents a single bond or an alkanediyl group with 1 to 8 carbon atoms. Two R^{E9}s in the formula may be the same or different from each other. Two R^{E11}s in the formula may be the same or different from each other.

The details of the above photoreceptor are the same as those of the photoreceptor to be manufactured by the photoreceptor manufacturing method according to the first aspect. Th details of the respective components to be contained in the above photoreceptor are the same as those of the respective components to be contained in the coating liquid for photosensitive layer formation as described in association with the first aspect. The lower alcohol as contained in the photosensitive layer is a residual portion of the first solvent in the coating liquid for photosensitive layer formation.

The polyarylate resin (PA2) is the same as the polyarylate resin (PA1) as described in association with the first aspect. Consequently, the description on R¹¹ through R¹⁴, X, R²⁰, p and q in General Formulae (20), (21) and (Y) that is made in association with the third aspect is the same as that on R¹¹ through R¹⁴, X, R²⁰, p and q in General Formulae (1), (2) and (Y) that is made in association with the first aspect.

The photoreceptor manufacturing method according to the first aspect and the coating liquid for photosensitive layer formation according to the second aspect, both described above, make it possible to obtain a photoreceptor allowing the suppression of a ghost image. The photoreceptor according to the third aspect allows the suppression of a ghost image. Th following description is made on an image forming apparatus using the photoreceptor of the third aspect.

(Fourth Aspect: Image Forming Apparatus)

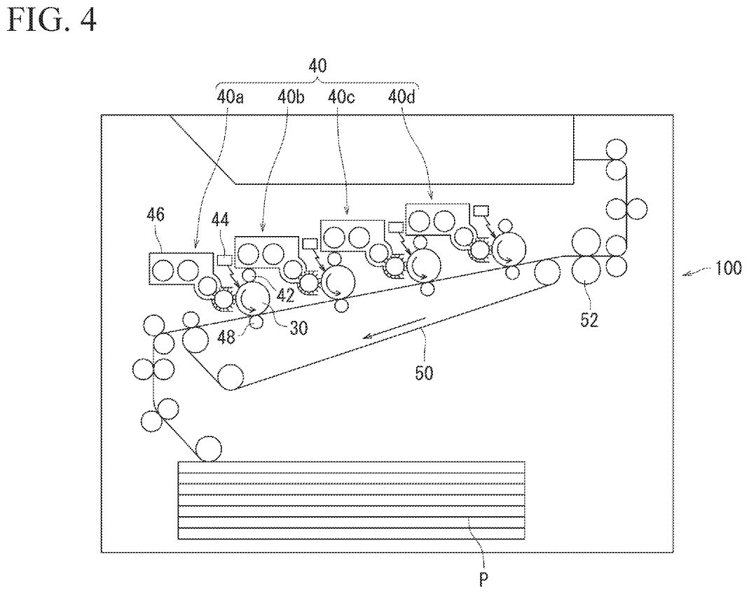

The image forming apparatus according to a fourth aspect of the present disclosure includes an image bearing member, a charger for charging a surface of the image bearing member, an exposure unit for exposing the charged surface of the image bearing member to light to form an electrostatic latent image on the surface of the image bearing member, a development unit for developing the electrostatic latent image to a toner image, and a transfer unit for transferring the toner image from the image bearing member to a transfer member. The image bearing member is in the form of the photoreceptor according to the third aspect. The image forming apparatus according to the fourth aspect includes the photoreceptor according to the third aspect as an image bearing member, so that a ghost image is suppressed on the apparatus. As an embodiment of the image forming apparatus according to the fourth aspect, a tandem color image forming apparatus is described by way of example with reference to FIG. 4.

An image forming apparatus 100 shown in FIG. 4 includes image forming units 40a, 40b, 40c and 40d, a transfer belt 50, and a fixing unit 52. In the following, the image forming units 40a, 40b, 40c and 40d are each referred to as “image forming unit 40” unless they need to be distinguished from one another.

The image forming unit 40 includes an image bearing member 30, a charger 42, an exposure unit 44, a development unit 46, and a transfer unit 48. The image bearing member 30 is the photoreceptor 1 according to the third aspect. The image bearing member 30 is provided in a middle position of the image forming unit 40. The image bearing member 30 is provided rotatably in the direction of arrow (counterclockwise direction). The charger 42, the exposure unit 44, the development unit 46, and the transfer unit 48 are aligned in this order, starting from the charger 42 on the upper stream of the rotating direction of the image bearing member 30, so that they may surround the image bearing member 30. The image forming unit 40 may further include one or both of a cleaner (not shown, specifically a blade cleaner) and a charge neutralizer (not shown). It should be noted that the image forming unit 40 may include no cleaning blades. In other words, the image forming apparatus 100 may employ a blade-cleaningless system.

By each of the image forming units 40a through 40d, toner images of a plurality of colors (for example, four colors of black, cyan, magenta and yellow) are sequentially superimposed on a recording medium M on the transfer belt 50.

The charger 42 charges a surface (specifically, the circumferential surface) of the image bearing member 30. The charging polarity of the charger 42 is positive. Accordingly, the charger 42 positively charges the surface of the image bearing member 30.

The charger 42 is in the form of a charging roller. The charging roller charges the surface of the image bearing member 30 while in contact with the surface of the image bearing member 30. The image forming apparatus 100 employs a contact charging method. Exemplary chargers of a contact charging type include a charging brush apart from the charging roller. The charger may be of a noncontact type. Exemplary noncontact chargers include a corotron charger and a scorotron charger.

In general, an image forming apparatus equipped with a charging roller as a charger tends to readily generate a ghost image. This is because the image forming apparatus whose charger is a charging roller tends to have a short charging time as compared with an image forming apparatus using a charger of other charging type (a noncontact charger, in particular) and is liable to be affected by the residual charge in the photosensitive layer, if any. The image forming apparatus 100 includes the photoreceptor 1 according to the third aspect as the image bearing member 30. The photoreceptor 1 allows the suppression of a ghost image. Consequently, on the image forming apparatus 100 which includes the photoreceptor 1 as the image bearing member 30, a ghost image is suppressed even if a charging roller is used as a charger.

The exposure unit 44 exposes the charged surface of the image bearing member 30. As a result, an electrostatic latent image is formed on the surface of the image bearing member 30. The electrostatic latent image is formed on the basis of the image data as input to the image forming apparatus 100.

The development unit 46 supplies toner to the surface of the image bearing member 30. The electrostatic latent image is thus developed by the development unit 46 to a toner image. As a result, the image bearing member 30 bears the toner image. The developer to be used may be a one-component developer or a two-component developer. If a one-component developer is used, the development unit 46 supplies the electrostatic latent image as formed on the surface of the image bearing member 30 with the toner which is the one-component developer. If a two-component developer including toner and a carrier is used, the development unit 46 supplies the electrostatic latent image as formed on the surface of the image bearing member 30 with the toner of the developer.

Preferably, the development unit 46 cleans a surface 1a of the photoreceptor 1. In other words, the image forming apparatus 100 preferably employs a blade-cleanerless system. In general, a blade-cleanerless image forming apparatus tends to readily generate a ghost image. The image forming apparatus 100 includes the photoreceptor 1 according to the third aspect as the image bearing member 30. The photoreceptor 1 allows the suppression of a ghost image. Consequently, on the image forming apparatus 100 which includes the photoreceptor 1 as the image bearing member 30, a ghost image is suppressed even if the blade-cleanerless system is employed.

The transfer belt 50 conveys the recording medium M between the image bearing member 30 and the transfer unit 48. The transfer belt 50 is in the form of an endless belt. The transfer belt 50 is provided rotatably in the direction of arrow (clockwise direction).

The transfer unit 48 transfers the toner image as formed by the development unit 46 from the surface of the image bearing member 30 to a transfer member. The transfer member is the recording medium M. In other words, the image forming apparatus 100 is of a direct transfer type. As an example of the transfer unit 48, a transfer roller is mentioned.

In general, a direct transfer-type image forming apparatus tends to readily generate a ghost image as compared with an intermediate transfer-type image forming apparatus (image forming apparatus including an intermediate belt as a transfer member). The reason is as follows: The residual charge in the photosensitive layer of the image bearing member is partially removed under the influence of the transfer voltage. In the case of a direct transfer system, however, the transfer voltage tends to be set lower as compared with an intermediate transfer system, so that the residual charge in the photosensitive layer is less removed by the transfer voltage. As a result, in a direct transfer-type image forming apparatus, a charge is likely to remain in a photosensitive layer of an intermediate image bearing member to thereby make a ghost image easier to generate, as compared with an intermediate transfer-type image forming apparatus. The image forming apparatus 100 includes the photoreceptor 1 according to the third aspect as the image bearing member 30. The photoreceptor 1 allows the suppression of a ghost image. Consequently, on the image forming apparatus 100 which includes the photoreceptor 1 as the image bearing member 30, a ghost image is suppressed even if the direct transfer system is employed.

After the transfer unit 48 has transferred the toner image from the surface of the image bearing member 30 to the recording medium M as a transfer member, the region of the surface of the image bearing member 30 is not subjected to charge neutralization but charged again by the charger 42. In other words, the image forming apparatus 100 may employ a so-called charge-neutralizationless system. Generally, on an image forming apparatus employing the charge-neutralizationless system, a charge is likely to remain in the photosensitive layer of the image bearing member and, accordingly, a ghost image is readily generated. The image forming apparatus 100 includes the photoreceptor 1 according to the third aspect as the image bearing member 30. The photoreceptor 1 allows the suppression of a ghost image. Consequently, on the image forming apparatus 100 which includes the photoreceptor 1 as the image bearing member 30, a ghost image is suppressed even if the charge-neutralizationless system is employed.

The fixing unit 52 heats and/or presses the unfixed toner image as transferred to the recording medium M by the transfer unit 48. The fixing unit 52 is composed of a heating roller and/or a pressure roller. The toner image is fixed on the recording medium M by heating and/or pressing the toner image. As a result, an image is formed on the recording medium M.

While an example of the image forming apparatus according to the fourth aspect has been described, the image forming apparatus is not limited to the image forming apparatus 100 as above. The image forming apparatus 100, which is described above as a color image forming apparatus, may also be a monochromatic image forming apparatus. In that case, the image forming apparatus only needs to include a sole image forming unit, for instance. In addition, the image forming apparatus 100, which is described above as a tandem image forming apparatus, may also be of a rotary type.

### Examples

In the following, the present disclosure is more specifically described using examples. The present disclosure, however, is in no way limited to the scope of the examples.

The following charge generating agent, binder resin, hole transport material and electron transport material were prepared as materials for forming the photosensitive layer of the photoreceptor.

(Charge Generating Agent)

As a charge generating agent, the charge generating agent (CGM-1) as stated in the description on the first aspect was prepared. The charge generating agent (CGM-1) was titanyl phthalocyanine represented by Chemical Formula (CGM-1) and having a Y-form crystal structure. That is to say, Y-form titanyl phthalocyanine was used in the examples.

(Binder Resin)

As a binder resin, the polyarylate resins (R-1) through (R-6) as stated in the description on the first aspect were prepared. The polyarylate resins (R-1) through (R-6) were synthesized by the following methods.

(Synthesis of Polyarylate Resin (R-2))

A three-necked flask was used as a reaction vessel. The three-necked flask was a 1 L three-necked flask equipped with a thermometer, a three-way cock, and a 200 mL dropping funnel. Into the reaction vessel, 12.24 g (41.28 milimole) of 1,1-bis(4-hydroxy-3-methylphenyl)cyclohexane, 0.062 g (0.413 milimole) of t-butyl phenol, 3.92 g (98 milimole) of sodium hydroxide, and 0.120 g (0.384 milimole) of benzyltributylammonium chloride were charged. Then, the inside of the reaction vessel was purged with argon. Subsequently, 300 mL of water was further charged into the reaction vessel. The internal temperature of the reaction vessel was raised to 50° C. The contents of the reaction vessel were agitated for one hour while maintaining the internal temperature of the reaction vessel at 50° C. Thereafter, the internal temperature of the reaction vessel was lowered to 10° C. As a result, an alkaline aqueous solution was obtained.

On the other hand, 4.10 g (16.2 milimole) of 2,6-naphthalenedicarboxylic acid dichloride and 4.10 g (16.2 milimole) of 1,4-naphthalenedicarboxylic acid dichloride were dissolved in 150 mL of chloroform (Amylene (registered trademark)-added product). As a result, a chloroform solution was obtained.

Then, the chloroform solution was slowly added dropwise from the dropping funnel to the alkaline aqueous solution over 110 minutes to initiate polymerization. The contents of the reaction vessel were agitated for four hours while adjusting the internal temperature of the reaction vessel to 15±5° C., so as to allow the polymerization to proceed.

Subsequently, the upper layer (water layer) of the contents of the reaction vessel was removed by decantation to obtain an organic layer. Into a 1 L three-necked flask, 400 mL of ion exchange water, then the obtained organic layer was charged. Further, 400 mL of chloroform and 2 mL of acetic acid were charged into the three-necked flask. The contents of the three-necked flask were agitated at room temperature (25° C.) for 30 minutes. Thereafter, the upper layer (water layer) of the contents of the three-necked flask was removed by decantation to obtain an organic layer. The obtained organic layer was washed 5 times with 1 L of water through a separatory funnel. As a result, a water-washed organic layer was obtained.

Next, the water-washed organic layer was filtered to obtain a filtrate. Into a 1 L Erlenmeyer flask, 1 L of methanol was charged. The obtained filtrate was slowly added dropwise to the Erlenmeyer flask to obtain a precipitate. The precipitate was filtered off by filtration. The obtained precipitate was vacuum dried at a temperature of 70° C. for 12 hours. As a result, the polyarylate resin (R-2) was obtained. The mass yield of the polyarylate resin (R-2) was 12.9 g, and the percentage yield thereof was 83.5 mol %.

(Synthesis of Polyarylate Resins (R-1) and (R-3) Through (R-6))

In the synthesis of the polyarylate resins (R-1) and (R-3) through (R-6), the monomers, into which the respective repeating units can be introduced and which are each represented by General Formula (1) or (2), were appropriately used as a monomer. Except for the above, the polyarylate resins (R-1) and (R-3) through (R-6) were synthesized following the synthesis procedure for the polyarylate resin (R-2).

A proton nuclear magnetic resonance spectrometer (manufactured by JASCO Corporation; 300 MHz) was used to measure ¹H-NMR spectra of the produced polyarylate resins (R-1) through (R-6). CDCl₃ was used as a solvent. Tetramethylsilane (TMS) was used as an internal standard sample. It was confirmed from the ¹H-NMR spectra that the polyarylate resins (R-1) through (R-6) were obtained.

The respective polyarylate resins had the following viscosity average molecular weights.

Polyarylate resin (R-1): 53,200

Polyarylate resin (R-2): 48,900

Polyarylate resin (R-3): 50,300

Polyarylate resin (R-4): 51,200

Polyarylate resin (R-5): 51,000

Polyarylate resin (R-6): 52,100

(Hole Transport Material)

As a hole transport material, the hole transport materials (11-H1), (11-H2), (11-H3), (13-H4), (12-H5) and (14-H6) as stated in the description on the first aspect were prepared.

(Electron Transport Material)

As an electron transport material, the electron transport materials (E-1) through (E-4) as stated in the description on the first aspect were prepared. The electron transport materials (E-3) and (E-4) were synthesized by the following methods.

(Synthesis of Electron Transport Material (E-3))

According to the reactions as represented by Reaction Formulae (r-a) and (r-b) (hereafter also referred to as “reactions (r-a) and (r-b),” respectively), the electron transport material (E-3) was synthesized.

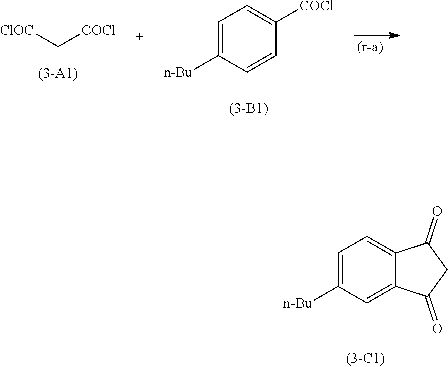

In the reaction (r-a), a compound (3-A1) and a compound (3-B1) were reacted to obtain a compound (3-C1). Specifically, 1.41 g (10 mmol) of the compound (3-A1), 1.96 g (10 mmol) of the compound (3-B1), and 3.96 g (30 mmol) of aluminum chloride were dissolved in nitrobenzene (30 mL). The obtained nitrobenzene solution was agitated at 80° C. for five hours in a nitrogen gas atmosphere. Then, a 10% aqueous oxalic acid solution (100 mL) was added to the nitrobenzene solution, extracted with chloroform, and the solvent was distilled off by distillation to obtain a residue. The residue was purified by silica gel column chromatography using chloroform as an eluent. The compound (3-C1) was thus obtained. The mass yield of the compound (3-C1) was 1.21 g. The percentage yield of the compound (3-C1) from the compound (3-A1) was 60%.

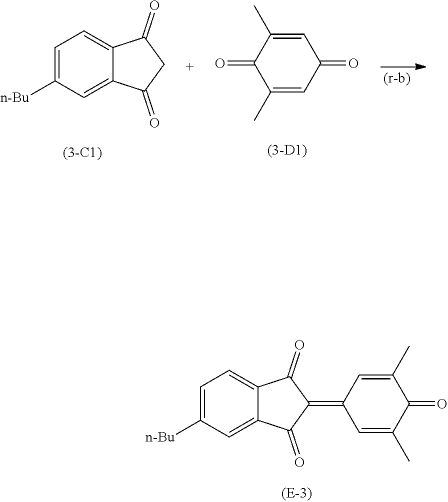

In the reaction (r-b), the compound (3-C1) and a compound (3-D1) were reacted to obtain the electron transport material (E-3). Specifically, 2.02 g (10 mmol) of the compound (3-C1) and 1.4 g (10 mmol) of the compound (3-D1) were dissolved in pyridine (50 mL). The resultant pyridine solution was agitated at room temperature (25° C.) for three hours. Thereafter, 100 mL of water was added to the pyridine solution, and the generated solid was collected by filtration. The collected solid was purified by silica gel column chromatography using chloroform as an eluent to obtain 1.60 g of the electron transport material (E-3). The percentage yield of the electron transport material (E-3) from the compound (3-C1) was 50%.

(Synthesis of Electron Transport Material (E-4))

According to the reactions as represented by Reaction Formulae (r-1) and (r-2) (hereafter also referred to as “reactions (r-1) and (r-2),” respectively), the electron transport material (E-4) was synthesized.

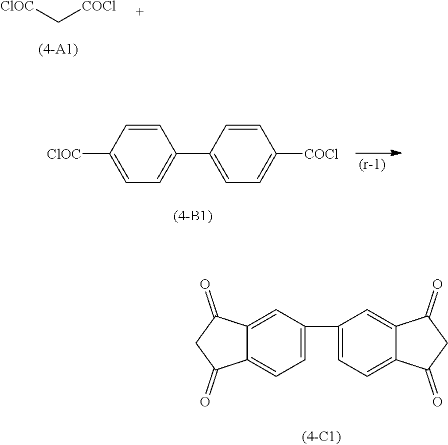

In the reaction (r-1), a compound (4-A1) and a compound (4-B1) were reacted to obtain a compound (4-C1). Specifically, 2.82 g (20 mmol) of the compound (4-A1), 2.79 g (10 mmol) of the compound (4-B1), and 7.92 g (60 mmol) of aluminum chloride were dissolved in nitrobenzene (50 mL). The obtained nitrobenzene solution was agitated at 80° C. for five hours in a nitrogen gas atmosphere. Then, a 10% aqueous oxalic acid solution (100 mL) was added to the nitrobenzene solution, extracted with chloroform, and the solvent was distilled off by distillation to obtain a residue. The residue was purified by silica gel column chromatography using chloroform as an eluent. The compound (4-C1) was thus obtained. The mass yield of the compound (4-C1) was 1.60 g. The percentage yield of the compound (4-C1) from the compound (4-A1) was 55%.

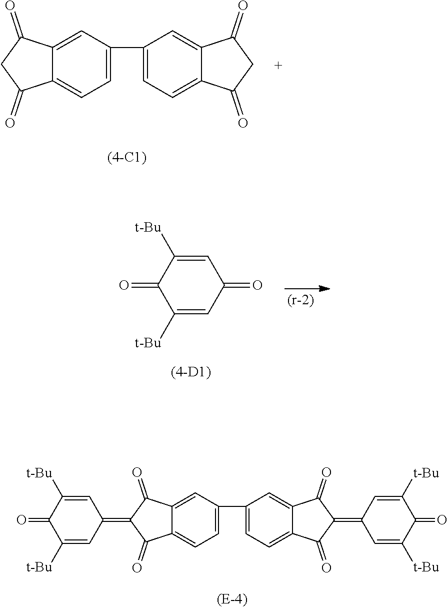 [SMILES: O=C1CC(=O)c2cc(-c3ccc4c(c3)C(=O)CC4=O)ccc21 ; CC(C)(C)C1=CC(=O)C=C(C(C)(C)C)C1=O ; CC(C)(C)C1=CC(=C2C(=O)c3ccc(-c4ccc5c(c4)C(=O)C(=C4C=C(C(C)(C)C)C(=O)C(C(C)(C)C)=C4)C5=O)cc3C2=O)C=C(C(C)(C)C)C1=O]

In the reaction (r-2), the compound (4-C1) and a compound (4-D1) were reacted to obtain the electron transport material (E-4). Specifically, 2.9 g (10 mmol) of the compound (4-C1) and 4.4 g (20 mmol) of the compound (4-D1) were dissolved in pyridine (50 mL). The resultant pyridine solution was agitated at room temperature (25° C.) for three hours. Thereafter, 100 mL of water was added to the pyridine solution, and the generated solid was collected by filtration. The collected solid was purified by silica gel column chromatography using chloroform as an eluent to obtain 3.47 g of the electron transport material (E-4). The percentage yield of the electron transport material (E-4) from the compound (4-C1) was 50%.

A ¹H-NMR (proton nuclear magnetic resonance spectrometer) was used to measure ¹H-NMR spectra of the electron transport materials (E-3) and (E-4). The magnetic field strength was set to 300 MHz. Deuterated chloroform (CDCl₃) was used as a solvent. Tetramethylsilane (TMS) was used as an internal standard substance. Chemical shift values of ¹H-NMR spectra of the electron transport materials (E-3) and (E-4) are shown below. The chemical structures of the electron transport materials (E-3) and (E-4) were confirmed from the chemical shift values of the measured ¹H-NMR spectra.

Electron transport material (E-3): ¹H-NMR (300 MHz, CDCl₃) δ=8.82 (d, 2H), 7.85-7.88 (m, 1H), 7.74-7.75 (m, 1H), 7.61-7.65 (m, 1H), 2.58 (t, 2H), 2.14 (s, 6H), 1.55-1.66 (m, 2H), 1.31-1.45 (m, 2H), 0.95 (t, 3H)

Electron transport material (E-4): ¹H-NMR (300 MHz, CDCl₃) δ=8.82-8.87 (m, 4H), 8.21-8.28 (m, 2H), 8.09-8.17 (m, 4H), 1.38 (s, 36H)

(Manufacture of Photoreceptor (A-1))

A container was charged with 2 parts by mass of the charge generating agent (CGM-1), 65 parts by mass of the hole transport material (11-H1), 35 parts by mass of the electron transport material (E-1), 100 parts by mass of the polyarylate resin (R-1) as a binder resin, 20 parts by mass of methanol as a first solvent, and 600 parts by mass of tetrahydrofuran as a second solvent. The materials and solvent (first and second solvents) in the container were mixed for two minutes using a rod-shaped ultrasonic vibrator, so as to disperse the materials in the solvent. A ball mill was used to further mix the materials and solvent in the container for 50 hours so as to disperse the materials in the solvent. Thus, a coating liquid for photosensitive layer formation was obtained. The obtained coating liquid for photosensitive layer formation was applied by dip coating onto a drum-shaped support made of aluminum and serving as a conductive substrate. The applied coating liquid for photosensitive layer formation was hot-air dried at 100° C. for 40 minutes. In this way, a photosensitive layer (with a thickness of 27 μm) was formed on a conductive substrate. As a result, a photoreceptor (A-1) was obtained as a single-layered photoreceptor.

(Photoreceptors (A-2) through (A-15) and Photoreceptors (B-1) through (B-6))

The above procedure for the photoreceptor (A-1) was followed to obtain photoreceptors (A-2) through (A-15) and photoreceptors (B-1) through (B-6) except that the components as set forth in Tables 2 and 3 below were used as a charge generating agent, a binder resin, a hole transport material, an electron transport material, a first solvent, and a second solvent.

In Tables 2 and 3, H-1 through H-7 in the “Hole transport material” columns designate the hole transport materials (11-H1), (11-H2), (11-H3), (13-H4), (12-H5), (14-H6) and (14-H7), respectively. R-1 through R-6 in the “Binder resin” columns designate the polyarylate resins (R-1) through (R-6), respectively. With respect to the solvent, the term “parts” refers to parts by mass on 100 parts by mass of a binder resin, the sign “%” refers to the ratio (% by mass) to the total mass of first and second solvents, the term “MeOH” refers to methanol, the term “THF” refers to tetrahydrofuran, and the sign “-” indicates the absence of the relevant component.

(Performance Evaluation of Photoreceptor)

(Sensitivity Characteristics)

The sensitivity characteristics were evaluated for each of the photoreceptors (A-1) through (A-15) and (B-1) through (B-6). The evaluation on the sensitivity characteristics was carried out in an environment at a temperature of 23° C. and a relative humidity of 50% RH. First, the surface of each photoreceptor was charged to +620 V using a drum sensitivity tester (manufactured by Gentec Co., Ltd.). Next, a band pass filter was used to extract a monochromatic light (wavelength, 780 nm; half-width, 20 nm; light intensity, 1.3 μJ/cm²) from white light of a halogen lamp. The surface of each photoreceptor was irradiated with the extracted monochromatic light. The surface potential of each photoreceptor was measured 0.08 seconds after the start of irradiation. The measured surface potential was taken as the post-exposure potential (unit: +V). A post-exposure potential with a smaller absolute value indicates that the photoreceptor in question is more excellent in sensitivity characteristics. A photoreceptor having a post-exposure potential with an absolute value of not more than 110 V is considered to have practically adequate sensitivity characteristics. The measured post-exposure potentials are set forth in Tables 2 and 3.

(Ghost Image)

For each of the photoreceptors (A-1) through (A-15) and (B-1) through (B-6), it was evaluated whether or not a ghost image was suppressed. The evaluation on ghost images was carried out in an environment at a temperature of 32.5° C. and a relative humidity of 80% RH.

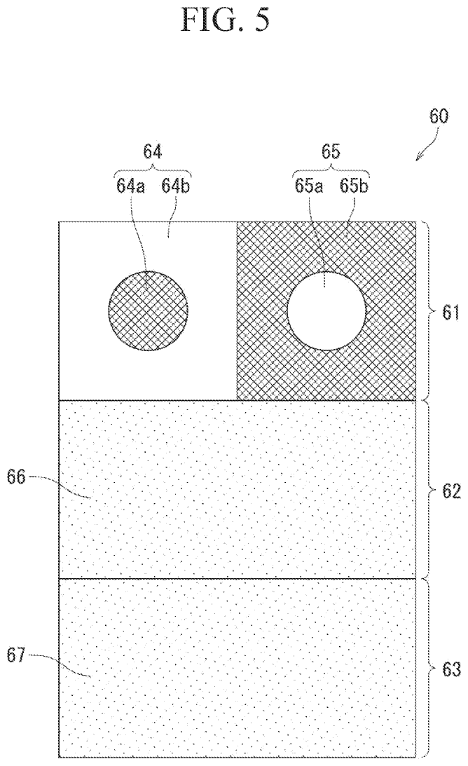

First, with reference to FIG. 5, an evaluation image 60 used for the evaluation on ghost images is described. FIG. 5 shows an evaluation image 60. The evaluation image 60 includes a first region 61, a second region 62, and a third region 63. The first region 61, the second region 62 and the third region 63 correspond to the regions of images formed in the first, second and third turns of the photoreceptor, respectively. The first region 61 includes a first image 64 and a second image 65. The first image 64 includes a first solid image 64a (image density 100%) and a first blank image 64b. The first solid image 64a is circular in shape. The first blank image 64b is the background of the first solid image 64a. The second image 65 includes a second blank image 65a and a second solid image 65b (image density 100%). The second blank image 65a is circular in shape. The second solid image 65b is the background of the second blank image 65a. The second region 62 includes a third image 66. The third image 66 is a full halftone image (image density 50%). The third region 63 includes a fourth image 67. The fourth image 67 is a full halftone image (image density 50%).

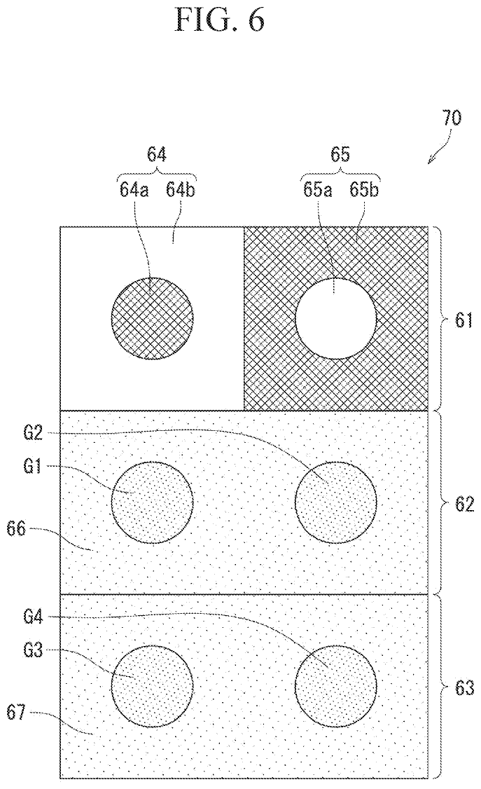

Second, with reference to FIG. 6, an image 70 having ghost images generated therein is described. The image 70 includes the first region 61, the second region 62, the third region 63, the first image 64, the first solid image 64a, the first blank image 64b, the second image 65, the second blank image 65a, the second solid image 65b, the third image 66 and the fourth image 67 as described with respect to the evaluation image 60.

If a ghost image is generated during the printing of the evaluation image 60, the third image 66 is not properly printed in the second region 62 but one or both of ghost images G1 and G2 appear in the third image 66 in the second region 62. The ghost images G1 and G2 each have an image density higher than that of the third image 66. The ghost image G1 is the image defect due to the exposure memory phenomenon, and has an image density higher than the design image density as a reflection of the first solid image 64a in the exposed region of the first image 64. The ghost image G2 is the image defect due to the transfer memory phenomenon, and has an image density higher than the design image density as a reflection of the second blank image 65a in the unexposed region of the second image 65.

If a ghost image is generated during the printing of the evaluation image 60, the fourth image 67 is not properly printed in the third region 63 but one or both of ghost images G3 and G4 appear in the fourth image 67 in the third region 63. The ghost images G3 and G4 each have an image density higher than that of the fourth image 67. The ghost image G3 is the image defect due to the exposure memory phenomenon, and has an image density higher than the design image density as a reflection of the first solid image 64a in the exposed region of the first image 64. The ghost image G4 is the image defect due to the transfer memory phenomenon, and has an image density higher than the design image density as a reflection of the second blank image 65a in the unexposed region of the second image 65. The above description has thus been made on the evaluation image 60 and the image 70 having ghost images generated therein.

Next, each photoreceptor was mounted on an evaluation machine for evaluation on ghost images. As an evaluation machine, a modified version of a color image forming apparatus (“FS-05250DN” manufactured by KYOCERA Document Solutions Inc.) was used. The evaluation machine as above employed a direct transfer system. The evaluation machine included a charging roller as a charger. The charging potential was set to +600 V. The evaluation machine did not include any cleaning blade as a cleaner. This evaluation machine had a configuration in which the development unit cleaned the surface of the image bearing member. The evaluation machine employed a contact development system.

The evaluation machine was used to print an image I (printing pattern image with 1% printing rate) on 500 sheets of recording medium (A4 size paper sheets), then print the evaluation image 60 as shown in FIG. 5 on one sheet of recording medium (A4 size paper sheet). This operation was repeated six times in succession to obtain a total of 3000 images I and a total of six evaluation images 60. The obtained six evaluation images 60 were each observed with the naked eye to determine whether or not the ghost images G1, G2, G3 and G4 as shown in FIG. 6 were generated. From the determination results, it was evaluated based on the following criteria whether or not the relevant photoreceptor allowed the suppression of a ghost image. During the evaluation, the worst of the evaluation results of the six evaluation images 60 was taken as the result of evaluation on ghost images of the relevant photoreceptor. The evaluation results are set forth in Tables 2 and 3. A photoreceptor with the evaluation criterium A or B is considered to allow the suppression of a ghost image.

(Criteria of Evaluation on Ghost Images)

A: None of the ghost images G1, G2, G3 and G4 was observed.

B: One or both of the ghost images G1 and G2 were slightly observed. However, neither the ghost image G3 nor G4 was observed.

C: One or both of the ghost images G1 and G2 were clearly observed. However, neither the ghost image G3 nor G4 was observed.

D: One or both of the ghost images G1 and G2 were clearly observed. In addition, one or both of the ghost images G3 and G4 were observed.

TABLE 2

| | | | | | | | | Evaluation | |
|---|---|---|---|---|---|---|---|---|---|
| | | | Solvent | | Hole | Electron | Charge | Post-exposure | |
| | | Binder | First | Second | transport | transport | generating | potential | Ghost image |
| | Photoreceptor | resin | solvent | solvent | material | material | agent | [+V] | suppression |
| Example 1 | A-1 | R-1 | MeOH | THF | H-1 | E-1 | CGM-1 | 78 | B |
| | | | 20 parts | 600 parts | | | | | |
| | | | (3.2%) | | | | | | |
| Example 2 | A-2 | R-2 | MeOH | THF | H-1 | E-1 | CGM-1 | 80 | B |
| | | | 20 parts | 600 parts | | | | | |
| | | | (3.2%) | | | | | | |
| Example 3 | A-3 | R-3 | MeOH | THF | H-1 | E-1 | CGM-1 | 79 | B |
| | | | 20 parts | 600 parts | | | | | |
| | | | (3.2%) | | | | | | |
| Example 4 | A-4 | R-4 | MeOH | THF | H-1 | E-1 | CGM-1 | 80 | B |
| | | | 20 parts | 600 parts | | | | | |
| | | | (3.2%) | | | | | | |
| Example 5 | A-5 | R-5 | MeOH | THF | H-1 | E-1 | CGM-1 | 81 | B |
| | | | 20 parts | 600 parts | | | | | |
| | | | (3.2%) | | | | | | |
| Example 6 | A-6 | R-6 | MeOH | THF | H-1 | E-1 | CGM-1 | 79 | B |
| | | | 20 parts | 600 parts | | | | | |
| | | | (3.2%) | | | | | | |
| Example 7 | A-7 | R-1 | MeOH | THF | H-2 | E-1 | CGM-1 | 68 | B |
| | | | 20 parts | 600 parts | | | | | |
| | | | (3.2%) | | | | | | |
| Example 8 | A-8 | R-1 | MeOH | THF | H-3 | E-1 | CGM-1 | 82 | B |
| | | | 20 parts | 600 parts | | | | | |
| | | | (3.2%) | | | | | | |
| Example 9 | A-9 | R-1 | MeOH | THF | H-4 | E-1 | CGM-1 | 102 | B |
| | | | 20 parts | 600 parts | | | | | |
| | | | (3.2%) | | | | | | |
| Example 10 | A-10 | R-1 | MeOH | THF | H-5 | E-1 | CGM-1 | 94 | B |
| | | | 20 parts | 600 parts | | | | | |
| | | | (3.2%) | | | | | | |
| Example 11 | A-11 | R-1 | MeOH | THF | H-6 | E-1 | CGM-1 | 65 | A |
| | | | 20 parts | 600 parts | | | | | |
| | | | (3.2%) | | | | | | |
| Example 12 | A-12 | R-1 | MeOH | THF | H-7 | E-1 | CGM-1 | 61 | A |
| | | | 20 parts | 600 parts | | | | | |
| | | | (3.2%) | | | | | | |
| Example 13 | A-13 | R-1 | MeOH | THF | H-1 | E-2 | CGM-1 | 77 | B |
| | | | 20 parts | 600 parts | | | | | |
| | | | (3.2%) | | | | | | |
| Example 14 | A-14 | R-1 | MeOH | THF | H-1 | E-3 | CGM-1 | 55 | A |
| | | | 20 parts | 600 parts | | | | | |
| | | | (3.2%) | | | | | | |
| Example 15 | A-15 | R-1 | MeOH | THF | H-1 | E-4 | CGM-1 | 58 | A |
| | | | 20 parts | 600 parts | | | | | |
| | | | (3.2%) | | | | | | |

TABLE 3

| | | | | | | | | Evaluation | |
|---|---|---|---|---|---|---|---|---|---|
| | | | Solvent | | Hole | Electron | Charge | Post-exposure | |
| | | Binder | First | Second | transport | transport | generating | potential | Ghost image |
| | Photoreceptor | resin | solvent | solvent | material | material | agent | [+V] | suppression |
| Comparative | B-1 | R-1 | — | THF | H-1 | E-1 | CGM-1 | 91 | D |
| Example 1 | | | | 600 parts | | | | | |
| Comparative | B-2 | R-2 | — | THF | H-1 | E-1 | CGM-1 | 90 | D |
| Example 2 | | | | 600 parts | | | | | |
| Comparative | B-3 | R-3 | — | THF | H-1 | E-1 | CGM-1 | 88 | D |
| Example 3 | | | | 600 parts | | | | | |
| Comparative | B-4 | R-4 | — | THF | H-1 | E-1 | CGM-1 | 93 | D |
| Example 4 | | | | 600 parts | | | | | |
| Comparative | B-5 | R-5 | — | THF | H-1 | E-1 | CGM-1 | 91 | D |
| Example 5 | | | | 600 parts | | | | | |
| Comparative | B-6 | R-6 | — | THF | H-1 | E-1 | CGM-1 | 90 | D |
| Example 6 | | | | 600 parts | | | | | |

As seen from Table 2, in the manufacture of the photoreceptors (A-1) through (A-15), a coating liquid for photosensitive layer formation containing a solvent, a charge generating agent, a binder resin, a hole transport material and an electron transport material was directly applied onto a conductive substrate and part of the solvent was removed so as to form a single-layered photosensitive layer. The solvent included the first solvent as an alcohol with 1 to 3 carbon atoms and the second solvent as a solvent other than the first solvent. The binder resin included one of the polyarylate resins (R-1) through (R-6) which are each a polymerized product of monomers including the monomer (1) as represented by General Formula (1) and the monomer (2) as represented by General Formula (2). The electron transport material included one of the electron transport materials (E-1) through (E-4) which are the compounds as represented by General Formulae (31) through (34), respectively.

As seen from Table 3, the coating liquids for photosensitive layer formation as used in the manufacture of the photoreceptors (B-1) through (B-6) contained the second solvent as a sole solvent and did not contain the first solvent.

As evident from Tables 2 and 3, the photoreceptors (A-1) through (A-15) allowed the suppression of a ghost image. In contrast, the photoreceptors (B-1) through (B-6) did not allow the suppression of a ghost image. It is considered from the above that a photoreceptor allowing the suppression of a ghost image is attained by making an alcohol with not more than 3 carbon atoms contained in a coating liquid for photosensitive layer formation.

As also evident from Tables 2 and 3, the photoreceptors (A-1) through (A-15) exhibited practically adequate sensitivity characteristics. Particularly, the photoreceptors (A-1) through (A-15) were likely to be excellent in sensitivity as compared with the Photoreceptors (B-1) through (B-6) if the same binder resin was used.

As described with respect to the first aspect, the reason for the ghost image suppression as allowed by the photoreceptors of Examples is considered to be that the residual amount of an aromatic dicarboxylic acid dichloride (monomer (2)) in the photosensitive layer is reduced by the reaction with the first solvent.

What is claimed is:

1. A method of manufacturing an electrographic photoreceptor provided with a conductive substrate and a single-layered photosensitive layer, the method comprising:
directly or indirectly applying a coating liquid for photosensitive layer formation onto the conductive substrate, the coating liquid containing a solvent, a charge generating agent, a binder resin, a hole transport material and an electron transport material; and
removing part of the solvent to form the single-layered photosensitive layer,
wherein the solvent includes a first solvent as an alcohol with 1 to 3 carbon atoms and a second solvent as a solvent other than the first solvent,
wherein the binder resin includes a polyarylate resin as a polymerized product of monomers including a first monomer represented by General Formula (1) and a second monomer represented by General Formula (2): 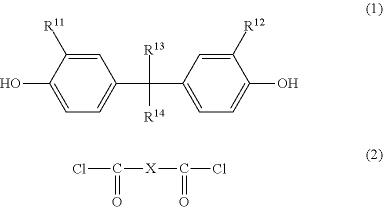
in General Formula (1), R¹¹ and R¹² each independently represent a hydrogen atom or an alkyl group with 1 to 4 carbon atoms and R¹³ and R¹⁴ each independently represent a hydrogen atom, an alkyl group with 1 to 4 carbon atoms or a phenyl group, or R¹³ and R¹⁴ are joined together to represent a divalent group represented by General Formula (Y): 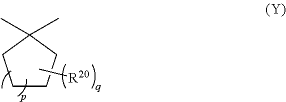
in General Formula (Y), R²⁰ represents a monovalent substituent, p represents an integer between 1 and 6 inclusive, and q represents an integer between 0 and 5 inclusive); and in General Formula (2), X represents a divalent group represented by Chemical Formula (X1), (X2), (X3) or (X4): 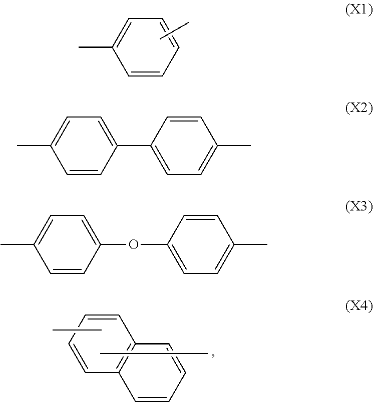
and
wherein the electron transport material includes a compound represented by General Formula (31), (32), (33) or (34): 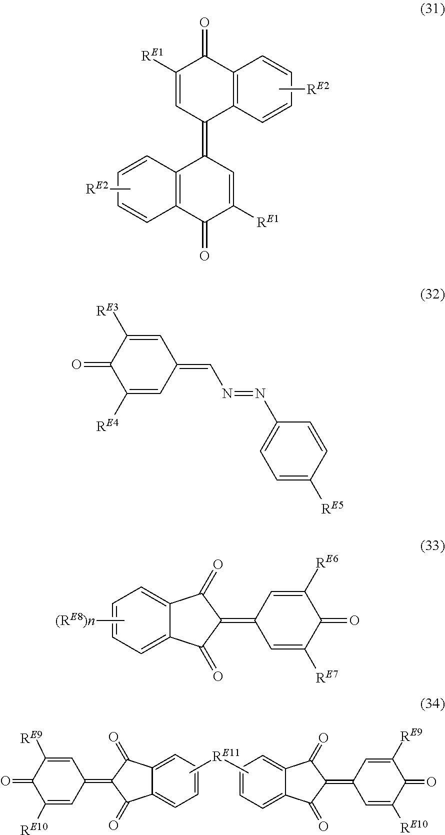
in General Formula (31), R^{E1} and R^{E2} each independently represent a hydrogen atom, an alkyl group with 1 to 8 carbon atoms, a phenyl group or an alkoxy group with 1 to 8 carbon atoms, whereupon two R^{E1} s in the formula may be the same or different from each other and two R^{E2}s in the formula may be the same or different from each other;
in the General Formula (32), R^{E3} and R^{E4} each independently represent a hydrogen atom, an alkyl group with 1 to 8 carbon atoms, a phenyl group or an alkoxy group with 1 to 8 carbon atoms, and R^{E5} represents a hydrogen atom, a halogen atom, an alkyl group with 1 to 8 carbon atoms, a phenyl group or an alkoxy group with 1 to 8 carbon atoms;
in General Formula (33), R^{E6} and R^{E7} each independently represent a hydrogen atom, an alkyl group with 1 to 8 carbon atoms, a phenyl group or an alkoxy group with 1 to 8 carbon atoms, R^{E8} represents an alkyl group with 1 to 8 carbon atoms, a phenyl group or an alkoxy group with 1 to 8 carbon atoms, and n represents an integer between 0 to 4 inclusive, whereupon a plurality of R^{E8}s in the formula may be the same or different from one another if n represents an integer that is 2 or higher; and
in General Formula (34), R^{E9} and R^{E10} each independently represent a hydrogen atom, an alkyl group with 1 to 8 carbon atoms, a phenyl group or an alkoxy group with 1 to 8 carbon atoms, and R^{E11} represents a single bond or an alkanediyl group with 1 to 8 carbon atoms, whereupon two R^{E9}s in the formula may be the same or different from each other and two R^{E10}s in the formula may be the same or different from each other.

2. The method of manufacturing an electrographic photoreceptor according to claim 1, wherein
the second solvent includes methylene chloride, chloroform, tetrahydrofuran or 1,3-dioxolane.

3. The method of manufacturing an electrographic photoreceptor according to claim 1, wherein
in General Formula (1), R¹³ and R¹⁴ are joined together to represent a divalent group represented by General Formula (Y) and, in General Formula (Y), q represents 0.

4. The method of manufacturing an electrographic photoreceptor according to claim 1, wherein
the first monomer is represented by Chemical Formula (1-1) or (1-2)

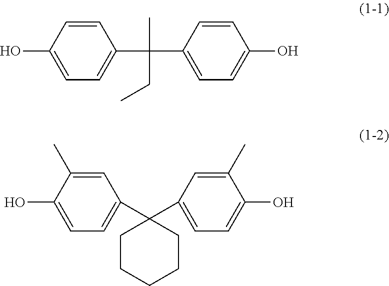 [SMILES: CCC(C)(c1ccc(O)cc1)c1ccc(O)cc1 ; Cc1cc(C2(c3ccc(O)c(C)c3)CCCCC2)ccc1O]

5. The method of manufacturing an electrographic photoreceptor according to claim 1, wherein
the polyarylate resin has at least one of repeating units represented by Chemical Formulae (r-1), (r-2), (r-3), (r-4), (r-5), (r-6) and (r-7)

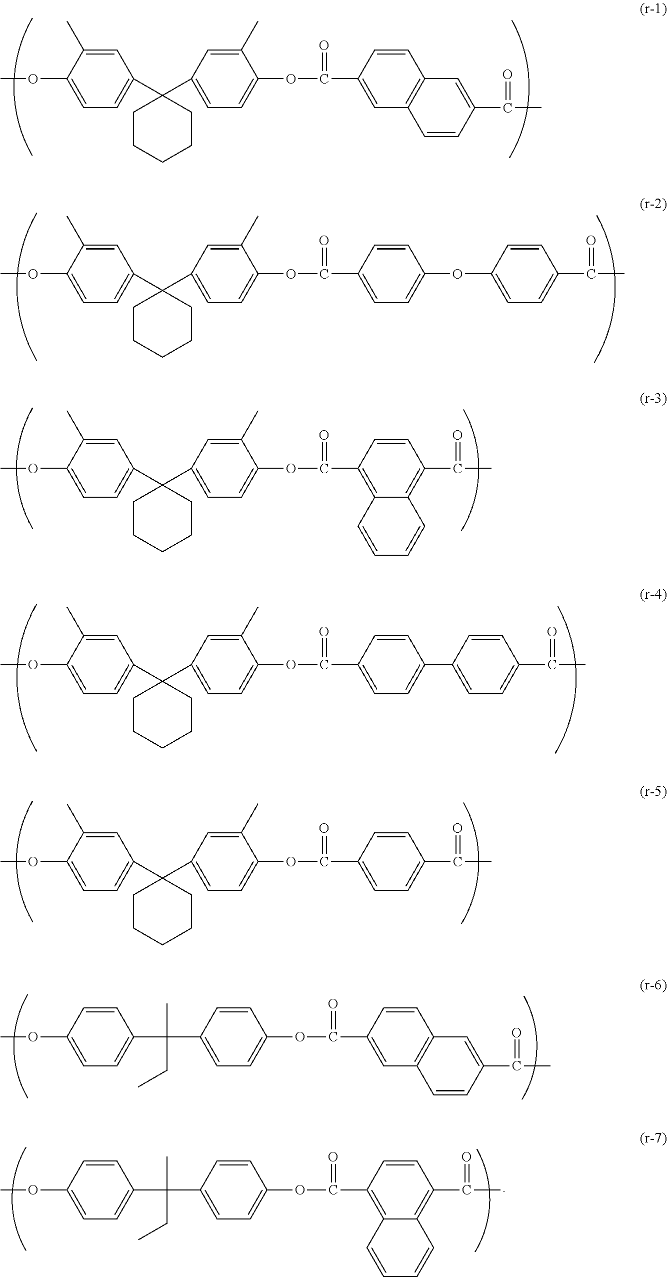

6. The method of manufacturing an electrographic photoreceptor according to claim 5, wherein
the polyarylate resin is represented by Chemical Formula (R-1), (R-2), (R-3), (R-4), (R-5), (R-6), (R-7) or (R-8)

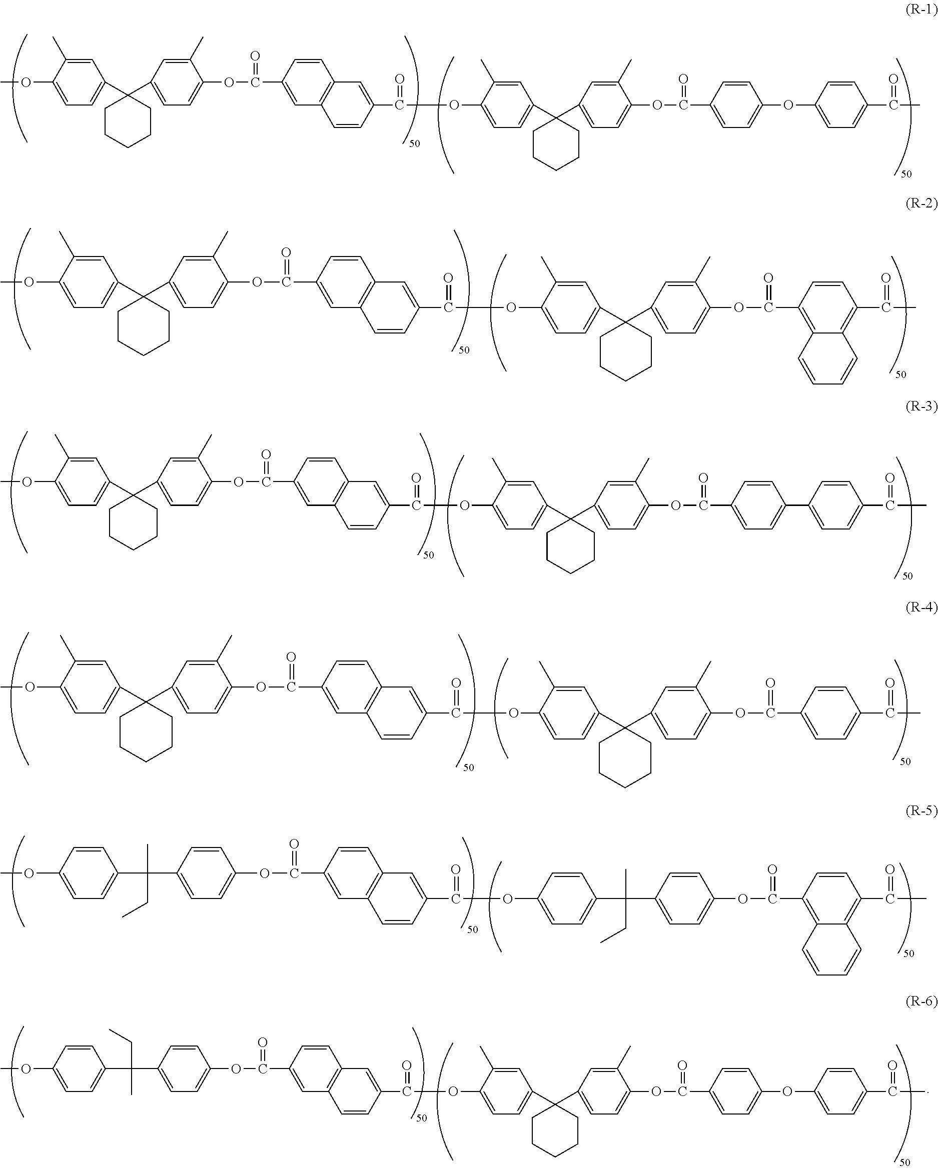

7. The method of manufacturing an electrographic photoreceptor according to claim 1, wherein
the hole transport material includes at least one of compounds represented by General Formulae (11), (12), (13) and (14): 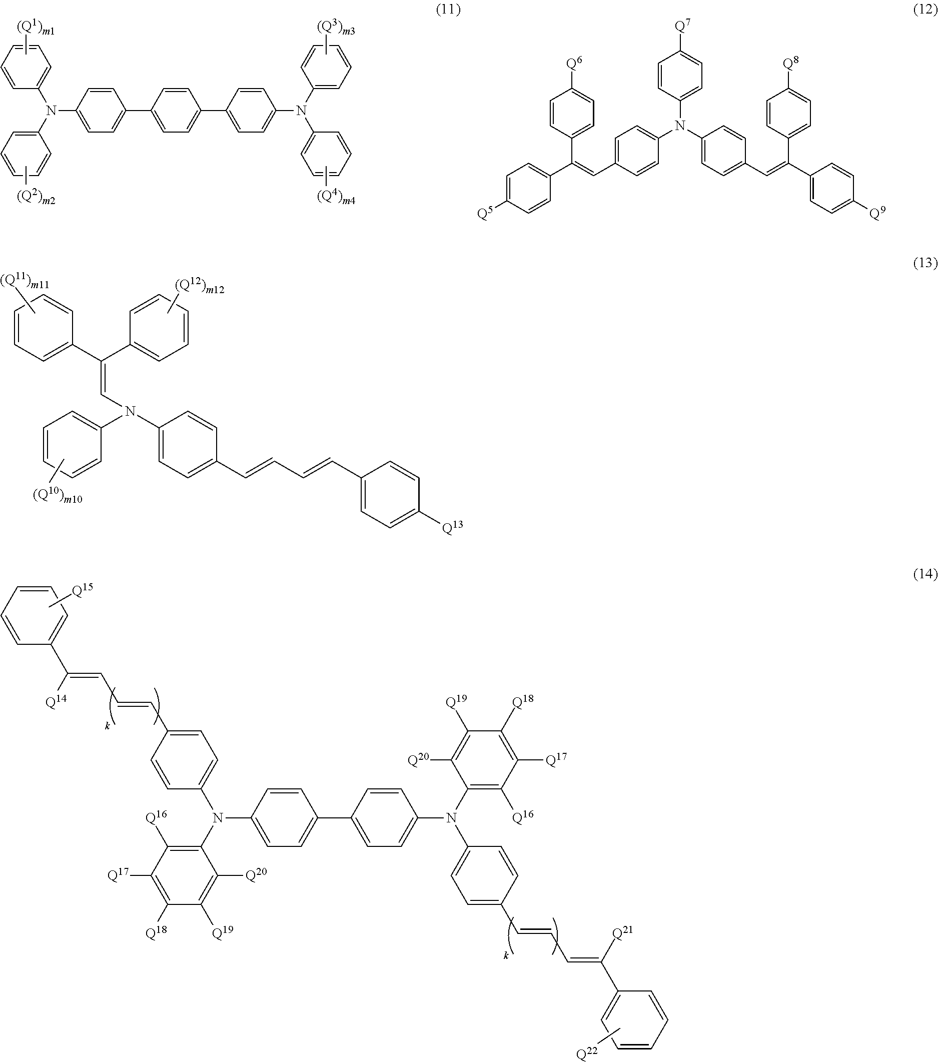
in General Formula (11),
Q¹ through Q⁴ each independently represent an alkyl group with 1 to 8 carbon atoms, a phenyl group or an alkoxy group with 1 to 8 carbon atoms, and
m1 through m4 each independently represent an integer between 0 to 2 inclusive;
in General Formula (12),
Q⁵ through Q⁹ each independently represent a hydrogen atom, an alkyl group with 1 to 8 carbon atoms, a phenyl group or an alkoxy group with 1 to 8 carbon atoms; in General Formula (13),
Q¹⁰ through Q¹² each independently represent an alkyl group with 1 to 8 carbon atoms, a phenyl group or an alkoxy group with 1 to 8 carbon atoms,
Q¹³ represents a hydrogen atom, an alkyl group with 1 to 8 carbon atoms, a phenyl group or an alkoxy group with 1 to 8 carbon atoms, and
m10 through m12 each independently represent an integer between 0 to 2 inclusive; and
in General Formula (14),
Q¹⁴ through Q²² each independently represent a hydrogen atom, an alkyl group with 1 to 8 carbon atoms, a phenyl group or an alkoxy group with 1 to 8 carbon atoms, and
k represents 0 or 1.

8. The method of manufacturing an electrographic photoreceptor according to claim 7, wherein:
in General Formula (11),
Q¹ and Q³ each independently represent an alkyl group with 1 to 4 carbon atoms or an alkoxy group with 1 to 4 carbon atoms,
Q² and Q⁴ each independently represent an alkyl group with 1 to 4 carbon atoms,
m1 and m3 each represent 1, and
m2 and m4 each independently represent 0 or 1;
in General Formula (12),
Q⁵ through Q⁹ each independently represent an alkyl group with 1 to 4 carbon atoms;
in General Formula (13),
Q¹³ represents a hydrogen atom, and
m10 through m12 each represent 0; and
in General Formula (14),
Q¹⁴, Q¹⁵, Q¹⁷, Q¹⁸, Q¹⁹, Q²¹ and Q²² each represent a hydrogen atom, and
Q¹⁶ and Q²⁰ each independently represent an alkyl group with 1 to 4 carbon atoms.

9. The method of manufacturing an electrographic photoreceptor according to claim 8, wherein
the compound represented by General Formula (11) is a compound represented by Chemical Formula (11-H1), (11-H2) or (11-H3), the compound represented by General Formula (12) is a compound represented by Chemical Formula (12-H5), the compound represented by General Formula (13) is a compound represented by Chemical Formula (13-H4), and the compound represented by General Formula (14) is a compound represented by Chemical Formula (14-H6) or (14-H7)

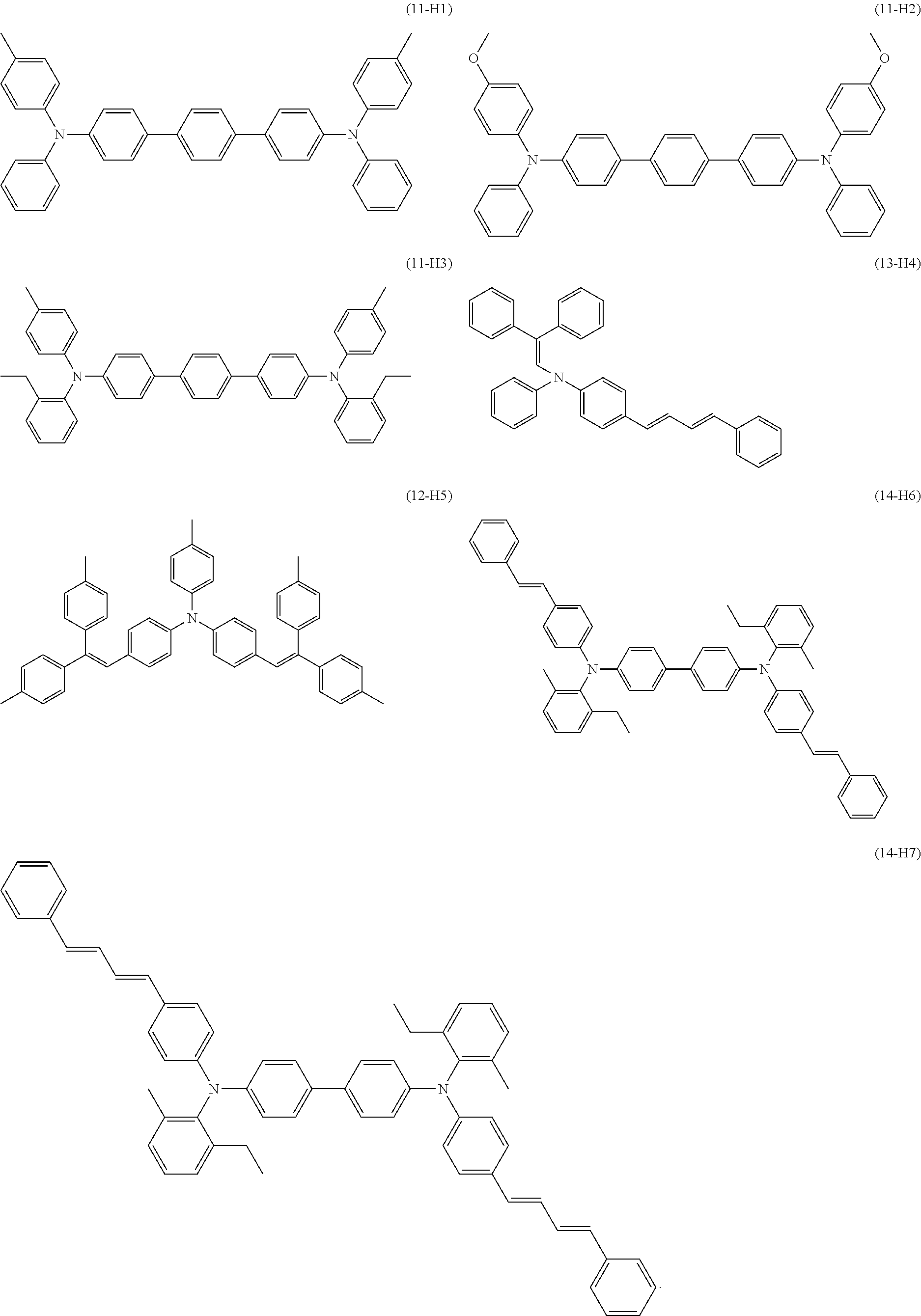

10. The method of manufacturing an electrographic photoreceptor according to claim 1, wherein
the compound represented by General Formula (31) is a compound represented by Chemical Formula (E-1), the compound represented by General Formula (32) is a compound represented by Chemical Formula (E-2), the compound represented by General Formula (33) is a compound represented by Chemical Formula (E-3), and the compound represented by General Formula (34) is a compound represented by Chemical Formula (E-4)

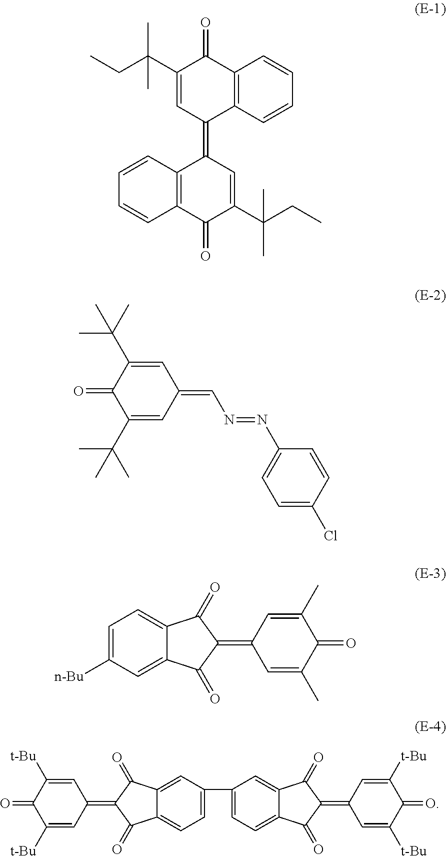

11. The method of manufacturing an electrographic photoreceptor according to claim 1, wherein
the first solvent is included in the solvent at a content ratio of 0.5 to 5.0% by mass.

12. The method of manufacturing an electrographic photoreceptor according to claim 1, wherein
the first solvent includes methanol.
